(19) United States
(12) Patent Application Publication
(10) Pub. No.: US 2025/0245494 A1
(43) Pub. Date: Jul. 31, 2025

(54) CODEBOOK COMPRESSION FOR VECTOR QUANTIZED NEURAL NETWORKS

(71) Applicant: QUALCOMM Incorporated, San Diego, CA (US)

(72) Inventors: Marinus Willem VAN BAALEN, Amsterdam (NL); Eric Wayne MAHURIN, Austin, TX (US); Paul Nicholas WHATMOUGH, Cambridge, MA (US); Andrey KUZMIN, Amsterdam (NL); Markus NAGEL, Amsterdam (NL); Tijmen Pieter Frederik BLANKEVOORT, Amsterdam (NL)

(21) Appl. No.: 18/821,925

(22) Filed: Aug. 30, 2024

Related U.S. Application Data
(60) Provisional application No. 63/627,725, filed on Jan. 31, 2024.

(51) Int. Cl. G06N 3/0495; G06N 3/084

(52) U.S. Cl. CPC G06N 3/0495; G06N 3/084

(57) ABSTRACT

Systems and techniques are described herein for quantizing a codebook used in the context of quantizing post-training parameters (e.g., vectors of weights) of a pre-trained model. For example, a device can perform rank reduction on a tensor of a codebook associated with parameters of a layer of a pre-trained machine learning model to generate a first tensor factor having a first shape and a second tensor factor having a second shape. The device can perform an optimization technique on the first tensor factor and the second tensor factor to minimize an output reconstruction error of the layer. The device can quantize the first tensor factor to generate a reduced size codebook.

### PRIORITY CLAIM

The present application claims priority to U.S. Provisional App. No. 63/627,725 filed on Jan. 31, 2024, the contents of which are incorporated herein by reference.

### TECHNICAL FIELD

The present disclosure generally relates to deep learning neural networks. For example, aspects of the present disclosure relate to quantizing a codebook used in the context of quantizing post-training parameters (e.g., vectors of weights) of a pre-trained model.

### BACKGROUND

Machine learning models (e.g., deep neural networks, such as large language models (LLMs), convolutional neural networks, transformers, diffusion models, etc.) are trained to provide an inference or prediction based on input data. For example, deep neural networks (e.g., LLMs, etc.) can be pre-trained on large datasets to generalize to a wide range of tasks. Applications of deep neural networks include text summarization, text generation, sentiment analysis, content creation such as performing generative operations, chatbots, virtual assistants, and conversational artificial intelligence, named entity recognition, speech recognition and synthesis, image annotation, text-to-speech synthesis, spell correction, machine translation, recommendation systems, fraud detection, accomplishing tasks and code generation.

However, generation of machine learning models is expensive to execute. The large expense can be based on a large number of parameters included in machine learning models, including deep neural networks. For instance, LLMs have a large number (e.g., billions) of parameters that need to be moved back and forth between memory for execution. One primary bottleneck for efficient LLM inference are weights. The cost of movement of parameters (e.g., weights) to and from memory is generally greater than the cost of calculation.

### SUMMARY

Systems and techniques are described herein for quantizing a codebook used in the context of quantizing post-training parameters (e.g., vectors of weights) of a pre-trained model. In some aspects, an apparatus for quantizing one or more machine learning models is provided. The apparatus includes at least one memory and at least one processor coupled to the at least one memory and configured to: perform rank reduction on a tensor of a codebook associated with parameters of a layer of a pre-trained machine learning model to generate a first tensor factor having a first shape and a second tensor factor having a second shape; perform an optimization technique on the first tensor factor and the second tensor factor to minimize an output reconstruction error of the layer; and quantize the first tensor factor to generate a reduced size codebook.

In some aspects, a method for quantizing one or more machine learning models is provided. The method includes performing rank reduction on a tensor of a codebook associated with parameters of a layer of a pre-trained machine learning model to generate a first tensor factor having a first shape and a second tensor factor having a second shape; performing an optimization technique on the first tensor factor and the second tensor factor to minimize an output reconstruction error of the layer; and quantizing the first tensor factor to generate a reduced size codebook.

In some aspects, an apparatus for quantizing one or more machine learning models is provided. The apparatus can include one or more of: means for performing rank reduction on a tensor of a codebook associated with parameters of a layer of a pre-trained machine learning model to generate a first tensor factor having a first shape and a second tensor factor having a second shape; means for performing an optimization technique on the first tensor factor and the second tensor factor to minimize an output reconstruction error of the layer; and means for quantizing the first tensor factor to generate a reduced size codebook.

In some aspects, a non-transitory computer-readable medium is provided having stored thereon instructions that, when executed by one or more processors, cause the one or more processors to: perform rank reduction on a tensor of a codebook associated with parameters of a layer of a pre-trained machine learning model to generate a first tensor factor having a first shape and a second tensor factor having a second shape; perform an optimization technique on the first tensor factor and the second tensor factor to minimize an output reconstruction error of the layer; and quantize the first tensor factor to generate a reduced size codebook.

In some aspects, one or more of apparatuses described herein include a mobile device (e.g., a mobile telephone or so-called “smart phone” or other mobile device), a wireless communication device, a vehicle or a computing device, system, or component of the vehicle or an autonomous driving vehicle, an extended reality device (e.g., a virtual reality (VR) device, an augmented reality (AR) device, an extended reality (XR) or a mixed reality (MR) device), a wearable device, a personal computer, a laptop computer, a server computer, a camera, or other device, devices used for image/video editing and image/video generation and editing. In some aspects, the one or more processors include an image signal processor (ISP). In some aspects, the apparatus includes a camera or multiple cameras for capturing one or more images. In some aspects, the one or more apparatuses include an image sensor that captures the image data. In some aspects, one or more apparatuses include a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating weight transfer overhead at inference time for a large language model, in accordance with some aspects of this disclosure;

FIG. 2 is a diagram illustrating the use of clusters of data and centroids, in accordance with some aspects of this disclosure;

FIG. 3 is a diagram illustrating the use of clusters of data with centroids and the use of reshaped weight tensors and codebooks, in accordance with some aspects of this disclosure;

FIG. 4 illustrates an example generative pre-trained transformer quantization, in accordance with some aspects of this disclosure;

FIG. 5A illustrates a block diagram including a vector quantization engine, in accordance with some aspects of this disclosure;

FIG. 5B is a diagram illustrating a vector quantization algorithm, in accordance with some aspects of this disclosure;

FIG. 6 is a diagram illustrating the use of groups, codebooks, and blocks including a plurality of groups, in accordance with some aspects of this disclosure;

FIG. 7 is a diagram that illustrate the use of data normalization in vector quantization, in accordance with some aspects of this disclosure;

FIG. 8 illustrates the use of a look up table to transition from an index matrix to a decoded weight matrix, in accordance with some aspects of this disclosure;

FIG. 9 illustrates a one-dimensional rank reduction of a matrix and a d-dimensional rank reduction of a matrix, in accordance with some aspects of this disclosure;

FIG. 10 illustrates an example process for reducing a size of a codebook used for vector quantization of a pre-trained model, according to some aspects of this disclosure;

FIG. 11 is a block diagram illustrating an example of a deep learning network, in accordance with some aspects of this disclosure; and

FIG. 12 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning models or systems (e.g., deep neural network (DNN) models or systems, such as large language models (LLMs), convolutional neural networks (CNNs), transformers, diffusion models, etc.) can be used to perform a variety of tasks such as, for example and without limitation, generative modeling such as text-to-image generation and text-to-video generation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some examples, a deep neural network model can include an LLM. LLMs can be pre-trained on large datasets and have a strong ability to generalize to a wide range of tasks when prompted appropriately. The sophistication and performance of an LLM can be based on the number of parameters (e.g., weights) of the LLM. Pre-trained generative models (e.g., transformer neural network architectures, such as Generative Pre-Trained (GPT) models) have shown break-through performance for complex language modelling tasks, leading to massive academic and practical interest.

The large computational and storage costs of deep neural network models (e.g., due to the storage of large numbers of parameters, including weights, of such models) can be an obstacle to using such models. For instance, some LLMs (e.g., GPT3-175B) have in the order of 175 billion parameters and require tens-to-hundreds of graphics processing unit (GPU) years to train. Even a simple task of inferencing over a pre-trained model is highly challenging. For instance, the parameters of GPT3-175B occupy 326 GB (counting in multiples of 1024) of memory when stored in a compact floating point (e.g., float16) format. However, the amount of memory exceeds the capacity of even the highest-end single GPUs, and thus inference must be performed using more complex and expensive setups, such as multi-GPU deployments.

A standard approach to addressing overhead of deep neural network models is model compression. Neural network quantization is commonly used to reduce model footprint, data transfer and compute requirements. By quantizing a model, high bit-width floating point weights and activations that are generally used for training can be represented by lower-precision values represented by fewer bits. Current approaches generally improve inference performance of models, at the cost of introducing noise in the models, resulting in a potential drop in accuracy. Little is known about compressing such models for inference. For instance, more complex techniques for low bit-width quantization or model pruning usually require model retraining, which is expensive for large models (e.g., billion-parameter models). Alternatively, post-training techniques that can compress a model in one shot (e.g., without retraining) would be beneficial. However, such techniques are complex and challenging to scale to billions of parameters. Only basic variants of round-to-nearest quantization have been applied at the scale of large deep neural network models (e.g., GPT-175B). Such a technique may work well for low compression targets (e.g., 8-bit weights), but fails to preserve accuracy at higher rates.

Existing approaches to neural network quantization can include uniform scalar quantization, non-uniform scalar quantization, and vector quantization. Each of these approaches affect the trade-off between compression and accuracy. For uniform quantization, a symmetric uniform quantizer with b bits of precision can be used to approximate an original floating point vector x as x≈sxᵢₙₜ, where xᵢₙₜ∈[−2^{b-1}, 2^{b-1}−1] is a b-bit integer value and s is a higher precision quantization scale, shared across the components of x. Using lower bitwidths yields larger benefits, at the expense of more quantization noise, which may harm model accuracy.

Another type of quantization is non-uniform quantization. In practice, neural network weights and activations are rarely distributed perfectly uniformly. Such a non-uniform distribution can be taken advantage of to improve accuracy by non-uniform quantization. In non-uniform quantization, floating point numbers are discretized to a limited set of flexibly assigned centroids C={c₁, c₂, . . . , cₖ}. Each floating point xᵢ is then represented by the index j of the closest centroids cⱼ. Such a solution compresses the bit-width of each value xᵢ to log₂ (k) and introduces extra overhead in storing a codebook C:j→cⱼ. The codebook can be stored as a look-up table.

Vector quantization is another form of quantization. A higher dimensionality can be chosen for the codebook C. Instead of mapping to a single number, d numbers can be used to map at the same time. In such cases, each centroid encodes d consecutive weights (e.g., pairs of weights if d=2). In the extreme case of cᵢ representing entire rows of a weight tensor, the approach is equivalent to vector quantization ( ).

There are variations in terms of the flexibility of a quantization grid used in neural network quantization. To compare the number of degrees of freedom for different quantization types, pairs of consecutive weights in two-dimensional space can be considered. For instance, a 3-bit uniform quantizer has 8 scalar quantization nodes. In such examples, a pair of weights effectively corresponds to 64 nodes which are arranged in a two-dimensional grid. A non-uniform quantizer with 8 nodes is a form of a 3-bit quantizer that has in two-dimensions a similar grid of 64 nodes with a less regular structure. In another example, a two-dimensional vector quantization with 64 centroids uses 3 bits per weight as log₂ (64)=6 and indices are shared among pairs of weights. The nodes are not in a grid anymore and can better represent the normally distributed data. Such a quantizer can be referred to as a two-dimensional 3-bit vector quantizer.

Various sets of possible two-dimensional quantization grids can be used for the quantization types. For example, for uniform quantization, the possible set of two-dimensional grids Gᵢₙₜ={(si, sj)} can be a pair of scaled integer values. Such a grid is equally spaced and therefore is the least flexible of the quantization types to consider. A more flexible grid corresponds to non-uniform quantization, G_{NUQ}=c×c, where the set of possibilities is the cartesian product of the two real numbers corresponding to the centroids cₖ. Each dimension is quantized independently, however the quantization grid along each dimension is not equally spaced and follows the data distribution. For vector quantization, a two-dimensional grid G_{PQ}=(x, y) can be used, where x, y∈ [symbol] is a pair of arbitrary floating-point numbers. The two coordinates are completely independent and thus it is the most flexible type of quantization grid. The nodes are able to closely follow the data distribution. It is noted that G_{INT}⊆G_{NUQ}⊆G_{PQ}, in which case the sets of possible grids for the three quantization types progressively extend each other. A similar observation can be made in a space of higher dimensionality. Further, increasing the dimensionality of vector quantization leads to increasingly more expressive quantization grids.

The level of quantization dimensionality affects quantization error (e.g., quantization error of neural network weights or other parameters). In some examples, signal-to-quantization noise ratio (SQNR) can be used as a metric to measure quantization error. SQNR is a normalized version of mean-squared error (MSE) mapped to log-scale. For instance, SQNR can be represented as follows: SQNR_{dB}=10 log₁₀ ( [symbol] [W²]/ [symbol] [(W−F(W))²]), where Wϵ [symbol] ^{n×m} are the weights, F(⋅) is a quantization function, and [symbol] represents expectation over all weights.

Quantization error can be measured depending on the types of the quantization grid, as adding additional degrees of expressivity to a quantization grid can lead to lower quantization error. For instance, three quantization grid types can be compared, with each using 3-bit per weight index. The dimensionality of vector quantization can be increased, such as up to four dimensions. To make a fair comparison, the codebook size can be set such that the overhead is always 0.25 b per weight. The results of such a comparison show that the SQNR grows while extra flexibility is added to the quantization grid. The SQNR can be increased further by increasing product quantization (PQ) dimensionality. Increasing dimensionality of PQ leads to exponentially increasing codebook size. For example, three-bit vector quantizer of dimension d requires 2^{3d} centroids for the codebook. In practice, going beyond 3-bits per weight may not be feasible for four-dimensional PQ.

Systems, apparatuses, electronic devices, methods (also referred to as processes), and computer-readable media (collectively referred to herein as “systems and techniques”) are described herein for quantizing a codebook to reduce overhead (e.g., when performing quantization for pre-trained models). The systems and techniques can be used for quantization of pre-trained models. Some techniques for quantization use linear quantization for deep neural network models (e.g., LLMs). According to some aspects, the systems and techniques described herein introduce approaches to improve compression processes by using non-linear quantization and increasing the dimensionality of a representable grid with vector quantization, in which several weights are quantized together enabling a more flexible quantization-grid across several dimensions.

The systems and techniques can provide post-training quantization, allow fast non-uniform and vector quantization, and improve the performance-size trade-off significantly when compared to existing approaches. Increasing the dimensionality of quantization results in improved accuracy versus model size trade-offs for many deep neural network models (e.g., LLMs). The systems and techniques described herein provide fast and accurate post-training and vector quantization compression and achieve a state of the art for size versus accuracy trade-offs on a wide range of LLMs. The systems and techniques provide vector quantization that leads to significant memory footprint reductions and on-device timing, providing improved latency compared to a 4-bit integer baseline.

As noted previously, going beyond 3-bits per weight may not be feasible for four-dimensional PQ. Aspects described herein thus include examples with two-dimensional and four-dimensional vector quantization. However, other dimensional vector quantization can be performed according to the systems and techniques described herein.

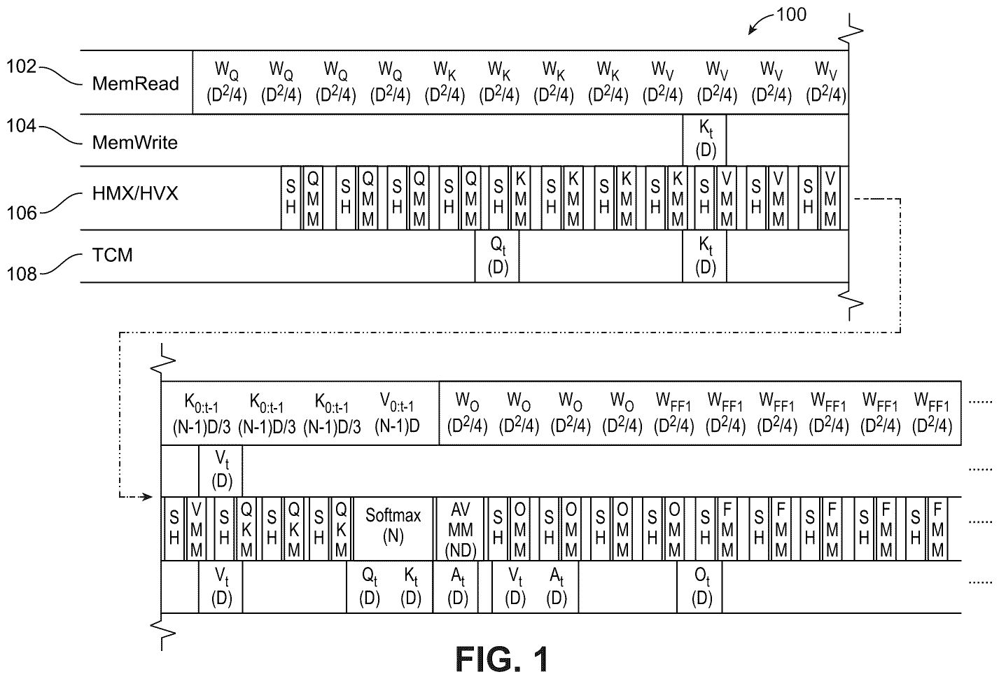

FIG. 1 illustrates a diagram 100 of LLM weight transfer overhead that occurs during inference time. Memory read 102 (MemRead) operations can be used to read parameters (e.g., weights) from memory into an array. Memory write 104 (MemWrite) operations can be performed to write data from an array to memory. In FIG. 1, the number of memory read 102 operations is high, for example compared to the number of memory write 104 operations. Hexagon Matrix eXtensions/Hexagon Vector extensions (HMX/HVX) 106 operations and periodic Tightly Coupled Memory (TCM) 108 operations are also shown in FIG. 1. HVX 106 is designed to allow significant compute workloads for advanced imaging and computer vision operations to be processed on a processor (e.g., a digital signal processor (DSP), a graphics processing unit (GPU), or other processor) instead of a central processing unit (CPU). TCM 108 provides low-latency memory access that a compute core (e.g., DSP, CPU, etc.) can use without the unpredictability of access associated with using cache memory (also referred to as cacheable memory). For example, storing data in cache memory enables fast access to the data. However, when the data is not stored in the cache, slower access to external memory is required. When using TCM 108, the access time is consistent as compared to using cache memory.

Various machine learning models (e.g., large language models (LLMs) such as GPT models, Open Pre-trained (OPT) models, etc.) can provide high quality performance across complex language modelling tasks. However, machine learning models with large numbers of parameters (e.g., LLMs) have high computational and storage costs, as illustrated in FIG. 1. For instance, due to the large number of parameters and size of such models, inference may require multiple performant processors (e.g., GPUs, DPSs, etc.), which limits the usability of such models.

As noted previously, model compression can be performed to allow large machine learning models to be used more efficiently. However, the applicability and performance of existing compression techniques is limited by the scale and complexity of large machine learning models (e.g., LLMs, such as GPT models). Various compression techniques use generative post-training quantization (GPTQ). GPTQ is a one-shot weight quantization method based on approximate second-order information. GPTQ can be both highly accurate and highly efficient. For instance, GPTQ can quantize GPT models with large numbers of parameters (e.g., 175 billion parameters) in approximately four GPU hours, reducing the bit-width to 3 or 4 bits per weight with negligible accuracy degradation relative to an uncompressed baseline. Such an approach can improve the compression gains relative to previously proposed one-shot quantization methods, preserve accuracy, allowing a large-parameter model to be executed inside a single GPU for generative inference.

A goal when compressing machine learning model weights (e.g., LLM weights) is to perform the compression with minimal loss of model accuracy. However, while various model compression techniques (e.g., GPTQ) provide reasonable accuracy in extreme quantization regimes (e.g., where weights are quantized to 2-bit or even ternary quantization levels), such techniques lead to model accuracy loss. Compression techniques are also limited to quantizing data according to a particular structure (e.g., on a column-by-column basis).

According to various aspects, the systems and techniques described herein can be used to quantize a codebook used for quantization. For example, post-training quantization can be performed on a pre-trained model (e.g., a deep neural network (DNN) model) to quantize parameters (e.g., weights) of the pre-trained machine learning model, in some cases on a layer-by-layer basis (or in some other fashion depending how the data is configured). The quantization can be performed based on sampled activations without a need for end-to-end fine-tuning. In some cases, a pre-trained model can be loaded and a layer in the model can be selected for quantization. Input activations to the layer can be sampled. Given the layer weights W and the sampled activation X, the error in the output activations can be minimized for that layer. Such a process can proceed layer by layer to quantize each uncompressed layer. Such a process can include minimizing a second order approximation of the output in some cases. The minimization can be performed using centroids and codebooks, as described herein. For instance, a Hessian matrix can be used to enable a vector quantization engine to select a nearest centroid in a codebook to the data to minimize the weight error, as well as the nearest centroid that minimizes the error in output activations for that layer. The use of codebooks also requires overhead.

The systems and techniques described herein can reduce overhead when performing quantization for pre-trained models. In some cases, for vector quantization, a set of N vectors can be obtained. For instance, each vector can be d-dimensional, where d is equal to or greater than 1. To save overhead, the systems and techniques described herein can store each individual vector and can establish a codebook of representative values (e.g., centroids) of the vectors. The codebook of representative values (e.g., centroids) has a dimension of K (with K referring to the number of representative values, such as the number of centroids). The dimension K of the codebook that is lower dimensional than N (K is a lower dimensional than N). Instead of storing each individual vector in the original data set, the systems and techniques can store an index in the codebook, where the index is closest to the original vector. By storing the index, such an approach does not require storing the entire vector. In some cases, the size of the index can be the number of bits needed to represent the index (e.g., the two logs of K). For instance, if there are sixteen centroids, then each index will be four bits.

The systems and techniques are not limited to any specific type of deep neural network (e.g., LLM) or parameters. For instance, the systems and techniques can be applied to any type of systems or process involving processing of large amounts of data where quantization can be applied. In some examples, the systems and techniques can be applied for any process or algorithm where codebooks are used for quantization. For instance, the systems and techniques can apply to codebooks used for integer quantization in which a plurality of columns or groups of data are to be processed simultaneously.

According to various aspects, the systems and techniques enable the introduction of a faster and more efficient model that can be deployed on devices (e.g., mobile devices, extended reality (XR) devices, vehicles or devices or systems of vehicles, etc.), including devices with less computing resources or on an edge node of a network. The systems and techniques can operate with any type of machine learning model (e.g., a DNN, such as an LLM, a CNN, a transformer model, a diffusion model, etc.). For instance, LLMs are massively memory-bound and have a large dynamic random-access memory (DRAM) footprint. Solving such issues for LLMs can provide many benefits. For example, the disclosed systems and techniques can alleviate both the extent of the DRAM footprint and memory bandwidth of such LLMs. Applying the systems and techniques can allow larger machine learning models (e.g., DNNs, such as LLMs) to be run on computing devices. The systems and techniques can also increase tokens per second for LLMs that can already run on existing computing devices.

In some aspects, at inference time in machine learning models, use of the vector quantization can reduce the overhead used to perform the inference operation. Vector quantization can be achieved using codebooks to reduce the amount of memory needed for the process as mentioned above and the overhead related to the use of codebooks relates to the fact that the codebook includes prototype vectors and an index tensor storing indices into the codebook. To further reduce overhead, the codebook itself can also be compressed using the systems and techniques described herein.

When compressing a machine learning model (e.g., a deep neural network), weights associated with the machine learning model or a layer in the machine learning model can be represented as a weight tensor. A machine learning model can include a large number of weight tensors. A weight tensor can be split into d-dimensional vectors. A set of codebooks can be generated for the d-dimensional vectors. As noted previously, instead of storing the original weight tensors, the systems and techniques can store indices for these d-dimensional vectors that are closest in the codebook.

In some aspects, the systems and techniques do not need one codebook for all of the weight tensors. For instance, multiple codebooks can be used for portions of the tensors (e.g., groups of weights within the tensors). For instance, tensors can be divided into groups (or blocks) that have d-dimensional vectors and an index can be used to represent each vector in a group. In order to store the model instead of the original weight tensors, the systems and techniques can use a set of indices. For each group, the systems and techniques can store the codebook for that group, in which case each group has a corresponding codebook, which can be different for every group.

In some cases, advanced reduced instruction set computer (RISC) machine (ARM) cores can be used to implement machine learning models (e.g., LLMs or other models). ARM cores have a lookup-table (LUT) instruction that maps sub-8-bit indices to 8-bit integers. Employing the LUT instruction allows for non-uniform quantization and vector quantization. In some aspects, a non-uniform scalar quantization is a one-dimensional form of non-uniform vector quantization. Both methods can be referred to as vector quantization herein. Vector quantization-based compression yields model DRAM footprint and data transfer benefits, over uniform (integer) quantization, in terms of trade-off between model size and accuracy. Vector quantization-compression gives better accuracy if a codebook is shared over fewer weights. When the number of weights the vector quantization codebook is shared with becomes very small, the codebook overhead becomes significant. For example, considering a LUT with 3-bit indices shared over 256 weights. the LUT contains 2³=8 8-bit values, corresponding to a LUT size of 64 bits. The weight indices are 3 bits each, corresponding to an index size=3*256=768 bits. The LUT overhead would be 64/768=8.3% or 0.25 bits per weight index. The effective weight bitwidth is 3.25 bits per weight, for 3-bit weight compression. The systems and techniques described herein provide an approach that reduces the codebook overhead with minimal impact on accuracy.

The timing of when the disclosed systems and techniques are applied can vary. In some aspects, the systems and techniques may be used at inference time and not when training a machine learning model (e.g., a deep neural network). In other aspects, the systems and techniques may be used at inference time and when training the machine learning model. The compression method can be used to make a pre-trained machine learning model faster at inference time. In some cases, weights of the machine learning model can be fixed in every forward pass, so that an encoding process can find the centroids and the assignments to the centroids and indices into the centroid codebook. The systems and techniques can then decode the data (e.g., numerous times).

Various aspects of the application will be described with respect to the figures.

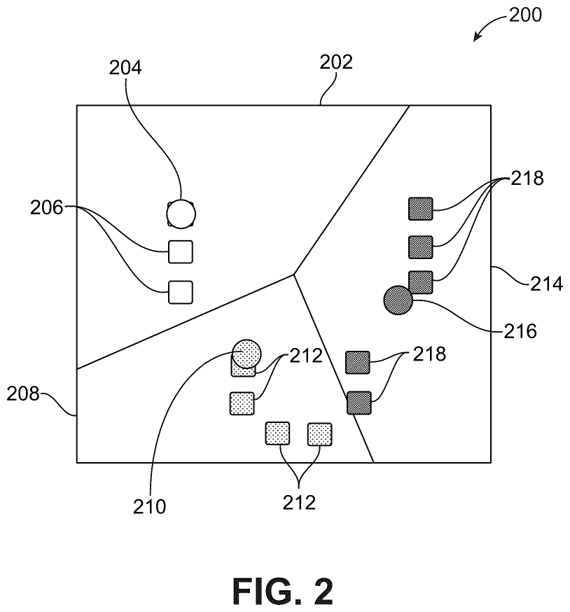

FIG. 2 illustrates an example of vector quantization (e.g., for compressing multi-dimensional data). Vector quantization is used for data compression where in some aspects, data is clustered using a classic K-means algorithm. The K-means algorithm involves grouping similar pixels into K clusters. Each cluster has a centroid in a codebook that includes representative shading for the pixels in the cluster, and one can map each pixel to the closest centroid within the cluster. The approach reduces the number of shades required to represent the image, and thus the size of the image data. FIG. 2 illustrates a group of clusters 200 that includes a first cluster 202 with a first centroid 204 with a first set of data 206. A second cluster 208 includes a second centroid 210 and a second set of data 212. A third cluster 214 includes a third centroid 216 and a third set of data 218. Each centroid can be used to approximate the neighboring data. When encoding, one can encode data related to the weight of each set of data including the first set of data 206, the second set of data 212, and the third set of data 218 by an index associated with the respective centroid such as the first centroid 204, the second centroid 210, and the third centroid 216. Typically, the number of centroids can be arranged as a power of 2 (e.g., 2, 4, 8, 16, etc.). A codebook can be stored which includes data for the coordinates of each of the respective centroids such as the first centroid 204, the second centroid 210, and the third centroid 216.

In some aspects, each data point can be represented using the associated centroid: Wϵ [symbol] ^{r×c}=>(Reshape) Wϵ [symbol] ^{n×d} where the data is reshaped from a row-by-column structure to a certain dimensionality of an array or matrix with n×d dimensions. One can choose parameters for the reshaping and other processes that include one or more of: vector quantization (VQ) dimensionality d, the number of cluster k, the group size l, and the codebook bit-width b.

Storing the codebook which corresponds to the coordinates of the respective centroids can be seen as overhead in which the bit used per weight element can be represented by the following: log₂ k+(k*d*b)/l.

As noted previously, systems and techniques are described herein for quantizing a codebook to reduce overhead (e.g., when performing quantization for pre-trained models). Various concepts related to vector dimensions apply when reducing the codebook size. The dimensionality of the vector (referred to as vector dimensionality) that the system encodes is one example. In another example, if there are large tensors and the vector dimensionality is two, then the system can take two adjacent weights and find a value in the codebook that can represent those two weights well. Another aspect of dimensionality relates to group size. For example, a weight tensor can be divided into groups. Each group can be assigned a corresponding codebook. The smaller the groups, if the codebook size is fixed, there are fewer vectors that need to be encoded. For instance, if there are sixteen vectors in a group, a codebook may also have sixteen vectors.

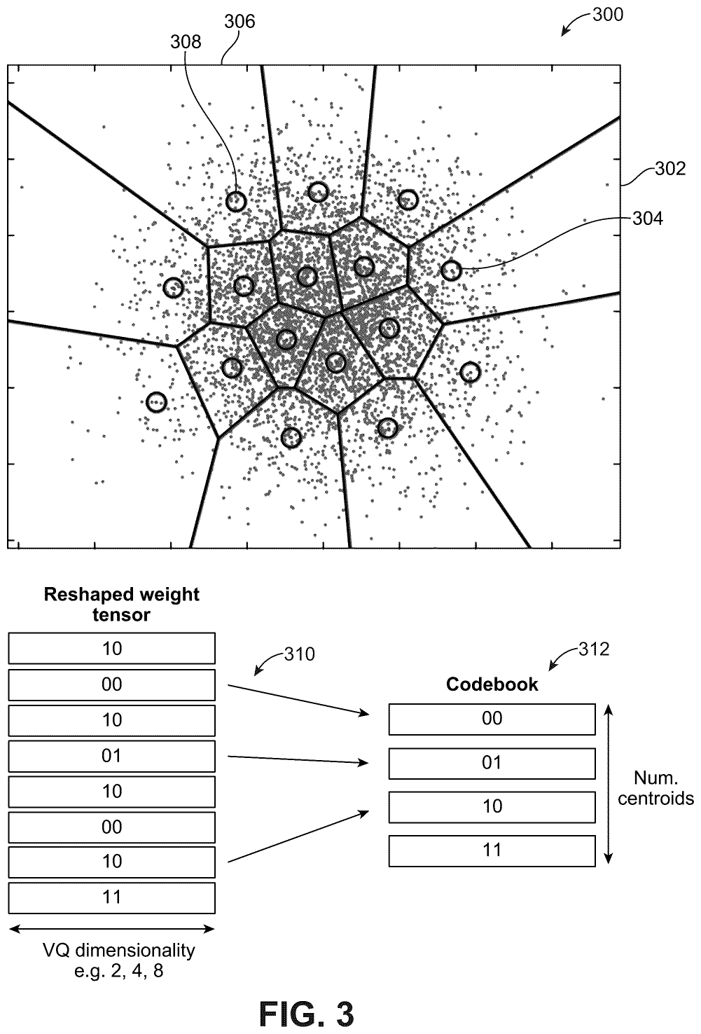

FIG. 3 is a diagram illustrating a vector quantization processing according to some aspects of this disclosure. A data field 300 includes a first cluster 302 showing a first centroid 304 and a second cluster 306 with a second centroid 308. Other clusters and centroids are shown as well. The data field 300 illustrates how the use of centroids can be implemented in the disclosure in connection with a codebook to select centroids as part of the quantization process that minimizes the output reconstruction error for a pre-trained model. A reshaped weight tensor 310 is shown with various values that conform to a vector quantization dimensionality (e.g., 2, 4, 8, etc.) that can correspond to a codebook 312 with various values according to a number of centroids.

The systems and techniques described herein can be applied to any vector quantization approach where codebooks are used, such as Generative Pre-trained Transformers Quantization (GPTQ).

As described above, quantization introduces quantization noise. Various techniques can be used to mitigate the effects of quantization noise on model accuracy. Post-training quantization (PTQ) approaches aim to mitigate the adverse effects of quantization noise on pre-trained networks, without having to resort to costly quantization-aware training (QAT). In some examples, weights can be modified to minimize output error of a layer as an approximation to the full loss of the network, such as using the following formulation:

$$𝔼 [ ℒ ( θ + ϵ ) ] = {\sum }_{ℓ} {‖ {W}^{ℓ} {X}^{ℓ} - {\hat{W}}^{{}_{ℓ}} {X}^{ℓ} ‖}_{F}^{2} , \qquad ( 1 )$$

where [symbol] is the weight for layer [symbol] , [symbol] is the (quantized) approximation to the weight tensor, and [symbol] of shape I×N denotes the input data for layer [symbol] from a calibration dataset, with N individual data points of dimensionality I along its columns.

Generative post-training quantization (GPTQ) is a quantization technique that follows Optimal Brain Quantization (OBQ), a recent Hessian-based quantization method, in using the Hessian of Equation (1). The Hessian can be efficiently computed as [symbol] . Like OBQ, GPTQ aims to minimize the Hessian-weighted error introduced by quantizing weights in [symbol] :

$$E = {\sum }_{q} {\vert {E}_{q} \vert}_{2}^{2} ; {E}_{q} = \frac{{W}_{: , q} - quant ( {W}_{: , q} )}{{[ {H}^{- 1} ]}_{q q}} , \qquad ( 2 )$$

GPTQ extends OBQ in various ways. For example, GPTQ exploits the fact that [symbol] is shared over all rows of [symbol] by quantizing all weights in a column in parallel, from left to right. After quantizing a column q, all remaining (unquantized) columns q′>q are modified with a Hessian-based update rule δ that absorbs the error introduced by quantizing column q on the layer's output:

$$δ = - \frac{{W}_{: , q} - quant ( {W}_{: , q} )}{{[ {H}^{- 1} ]}_{q q}} {H}_{: , ( q + 1 ) :} \qquad ( 3 )$$

To reduce data transfer, GPTQ applies the update of Equation (3) only to a small block of B columns in which column q resides. To update the columns outside of block B, the errors E_{q} in Equation (2) is accumulated while the columns in block B are processed and are applied in one go to all columns outside of block B after all columns in block B are processed. GPTQ also uses a Cholesky decomposition of the inverse Hessian H, which introduces a more numerically stable alternative to the inverse Hessian row and column removal operations.

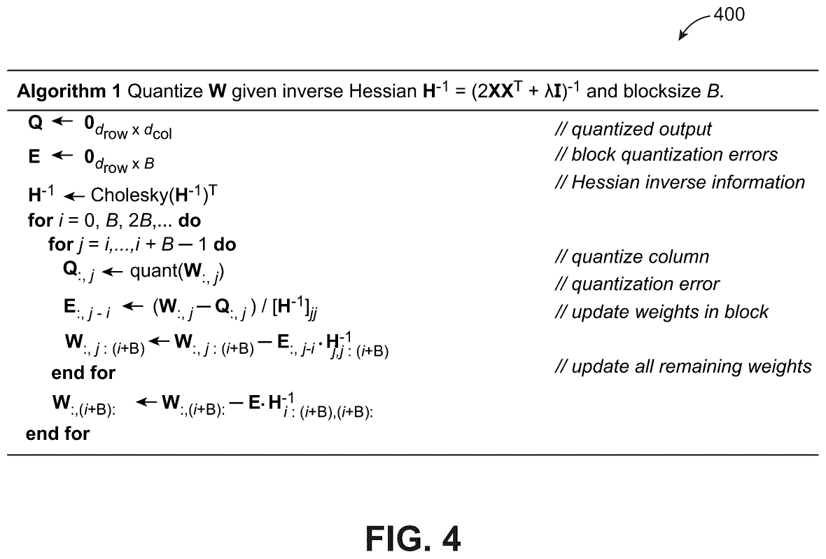

FIG. 4 illustrates an algorithm 400 for performing GPTQ using a method for integer post-training quantization. The quantization according to the algorithm 400 is performed on a column-by-column bases as the remaining weights are updated. The algorithm 400 involves quantizing W given an inverse Hessian H⁻¹=−(2XX^{T}+λI)⁻¹ and a blocksize B. The inverse Hessian H⁻¹ is a matrix that is the reciprocal of the Hessian matrix. The Hessian matrix is a square matrix of second-order partial derivatives of a scalar-valued function. The Hessian matrix provides information about the local curvature of a function at a particular point. The algorithm 400 includes quantizing an output on a row and column basis, determining block quantization errors, and obtaining the Hessian inverse information on a block-by-block basis. For each pair of blocks (B, 2B, etc.), such as when the dimensionality of vector quantization is 2D, the algorithm 400 includes quantizing on a column-by-column basis. The algorithm 400 further includes determining a quantization error, updating the weights in the block associated with a particular layer, and then update all remaining weights. The algorithm 400 incorporates the error in a particular layer into the other layers by updating remaining weights in uncompressed layers. The approach accumulates the error for the particular column and then updates the remaining columns based on that error. The Hessian function comes from a loss function approximation as is known in the art. In some aspects, updates to the remaining weights are performed in sub-blocks for efficiency purposes.

The systems and techniques described herein can be used to minimize part of the algorithm 400 for performing GPTQ to avoid the introduction of error during the compression. In some cases, the systems and techniques may not necessarily minimize the loss function directly, but may minimize its second-order approximation, in which case the Hessian is used. For example, the loss function is related to a loss generated by quantizing the weights, and the systems and techniques described herein can minimize a loss in the output of the data.

The systems and techniques described herein can be referred generative post-training vector quantization (GPTVQ), as the systems and techniques generalize the GPTQ method for nonuniform and vector quantization. For example, quantization of the weight tensor can be performed in a greedy manner starting from the first column. Given the PQ dimensionality d, quantization can be performed d columns at a time. In the case of scalar quantization, the optimal hessian-weighted quantization can be achieved by rounding to the nearest. However, in the case of vector quantization, choosing the nearest centroid may be suboptimal as an error in each of the d coordinates is weighted differently. The following can be used for choosing the optimal assignment j for a data point x⁽ⁱ⁾ and the corresponding sub-Hessian H⁽ⁱ⁾:

$$j = arg {{min}_{m} ( x - {c}^{( m )} )}^{T} {H}^{( i )} ( x - {c}^{( m )} ) . \qquad ( 4 )$$

After performing quantization of d columns, the remaining weights can be updated using an update rule. The update along d coordinates can be accumulated and applied on the remaining weights as a single operation.

To minimize the quantization error, several codebooks per layer can be used. Each codebook is assigned to a group of weights. Compared to scalar quantization, the granularity of the remaining weights is increased if d>1.

Codebook initialization can also be performed. To initialize the codebook for a group of weights, clustering can be performed using weighted K-means. For example, given the set of d-dimensional vectors x⁽ⁱ⁾, k centroid vectors c^{(m)} can be determined along with the corresponding sets of assignments Iₘ. The objective can be defined as the following sum of Hessian-weighted distance functions between the data points and the centroids:

$${min}_{I , {c}^{( 0 )} , … , ( k )} , {\sum }_{m = 0}^{k} {\sum }_{i ϵ {I}_{m}} {( {x}^{( i )} - {c}^{( m )} )}^{T} {H}^{( i )} ( {x}^{( i )} - {c}^{( m )} ) , \qquad ( 5 )$$

where H⁽ⁱ⁾ is a d×d subset of the inverse Hessian corresponding to the data point xⁱ. For example, for two-dimensional vector quantization, these matrices are share among pairs of columns.

The objective can be minimized using E- and M-steps. For example, E-step can include finding the assignment j for each unquantized d-dimensional vector x⁽ⁱ⁾ that minimizes an objective. Using the distance function above assigns optimal centroids based on the data-aware loss. The M-step can include finding the centroid value c^{(m)} that minimizes the following:

$${c}^{( m )} = arg {min}_{{{c}^{( m )}}^{}} {\sum }_{i ϵ {I}_{m}} ( {x}^{( i )} - {c}^{( m )} ) {H}^{( i )} ( {x}^{( i )} - {c}^{( m )} ) \qquad ( 6 )$$

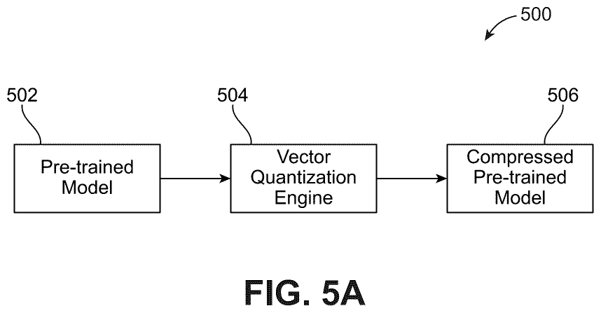

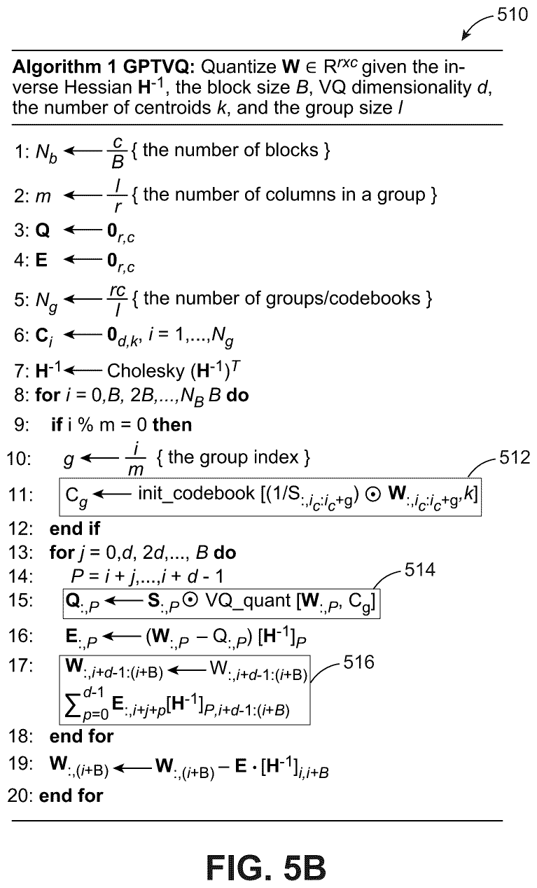

The objective is a quadratic form with respect to c⁽ⁱ⁾. The optimal value is computed in a closed form as c^{(m)}=(Σ_{i∈I}_{ₘ}H⁽ⁱ⁾)⁺(Σ_{i∈I}_{ₘ}H⁽ⁱ⁾x⁽ⁱ⁾), where (⋅)⁺ is a Moore-Penrose pseudoinverse. In some cases, during the vector quantization operation on line 15 in FIG. 5B, the assignment step defined in Equation (4) can be used. The Hessian diagonal or the full d-dim sub-Hessian can be used.

In some cases, block-wise VQ data normalization can be performed. In order to lower the error of vector quantization, block-wise data normalization can be applied to the data before the codebook initialization. For each group corresponding to a new codebook, element-wise division Wᵢ⊙(1/Sᵢ) of the weight sub-matrix matrix Wᵢ and the corresponding scales Sᵢ can be performed. The scale can be computed block-wise for every sub-row of Wᵢ, e.g., for a block size of 16, 32, or 64.

Given a set of blocks (sub-rows) w⁽ⁱ⁾, the scale sⁱ for each of the set of blocks is computed as

$${s}^{( i )} = {max}_{j} \vert 𝓌 \begin{matrix}( i ) \\ j\end{matrix} \vert .$$

In order to minimize the overhead, the scales are quantized to four-bit integer. In some cases, quantization can be performed in log-scale to capture several orders of magnitudes in weights. The quantized scales are computed as

$${S}_{i nt}^{( i )} = ⌈ \frac{{log}_{2} [ {s}^{( i )} ] - z}{a} ⌋ a ,$$

where a is the quantization scale shared within the group of weights. To accurately represent zero in log-space, which corresponds to unit scaling, the floating-point offset z can be used. The value of z is shared within the columns of W and thus has negligible overhead. The scaled sub-row can be normalized as w·2^{-a(s}^{ᵢₙₜ}^{-s}^{₀}⁾, where s₀=log₂ (z). The scaled data is used for codebook initialization. The inverse scaling is applied at PQ decoding step.

According to the algorithm 400, the vector quantization engine 504 (shown in FIG. 5A) quantizes multiple columns (two or more columns) at a time. If the data include a vector of “d” dimensions, the vector quantization engine 504 can quantize the vector and the d values are in the same row. Instead of processing column by column, the vector quantization engine 504 can process two-columns by two-columns by two-columns. In other cases, the dimension d may be 3, 4, or higher and the process could proceed for every three or four columns. In this regard, a chosen codebook spans multiple columns to correspond to multi-column data.

The output of the algorithm 400 is a set of quantized weights of a model or for a given dataset. In some cases, uniform quantization can be performed. However, any quantization method can be used for vector quantization. In some aspects, the systems and techniques described herein can determine a quantized weight that reconstructs the output as closely as possible or with minimal error. For example, the systems and techniques can find a quantization value that minimizes the output reconstruction error rather than minimizes the weight reconstruction error.

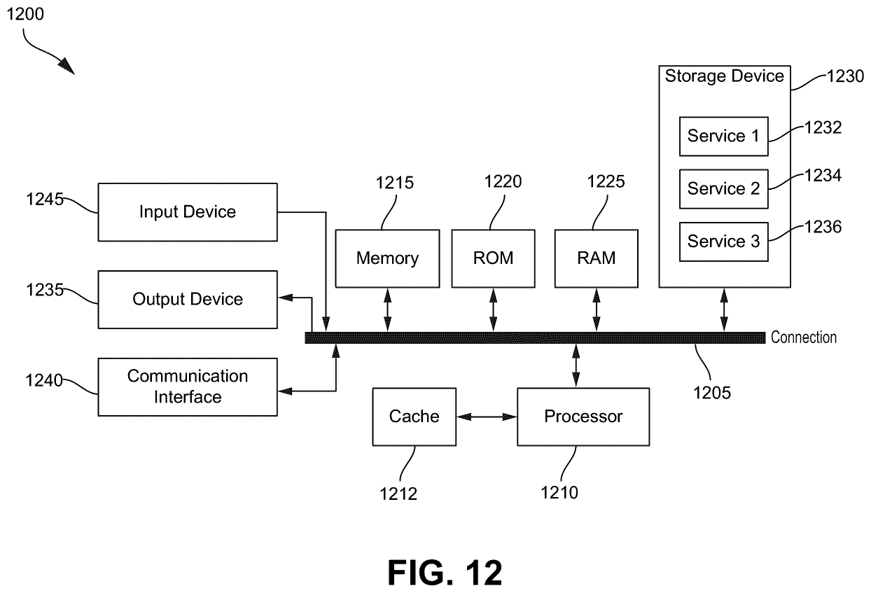

FIG. 5A illustrates a system 500 including input data of a pre-trained model 502 that is provided to a vector quantization engine 504. The vector quantization engine 504 can be a computing system (e.g., the system 1200 of FIG. 12) configured to perform vector quantization, such as through the combined use of hardware components configured through a module or software programming to performing the vector quantization operations disclosed herein. The output of the vector quantization engine 504 can be a compressed pre-trained model 506 as shown in FIG. 5A. Further, as disclosed more below, the vector quantization engine 504 may further perform codebook quantization in that the use of the codebook does add some overhead.

FIG. 5B illustrates an example algorithm such as a vector quantization algorithm 510 which operates to quantize input data (for example Wϵ [symbol] ^{r×c}, or weights in a row by column matrix) given the inverse Hessian H⁻¹, a block size B, a vector quantization dimensionality d, a number of centroids k, and a group size l. As shown in the vector quantization algorithm 510, rows 1-7 include various operations such as determining the number of blocks N_{b}, the number of columns in a group m, quantization values and error values, the number of groups/codebooks Ng, a value for a codebook Ci, and the inverse Hessian H⁻¹.

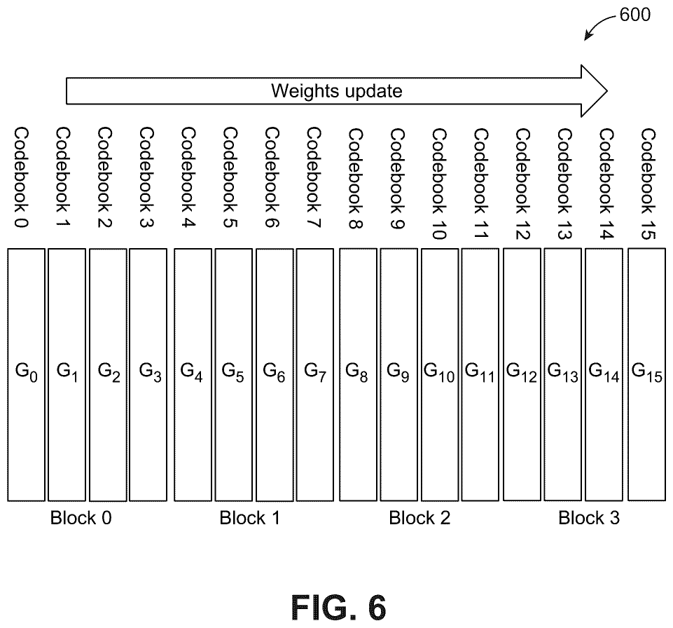

The discussion of FIG. 5B can be understood further with reference to FIG. 6 which shows a set of blocks 600 in which a block 0 includes four groups G₀, G₁, G₂, G₃. Each of the groups G₀, G₁, G₂, G₃ is assigned a respective codebook 0, codebook 1, codebook 2, and codebook 3. Each respective group can include multiple columns. As noted herein, the systems and techniques described herein can quantize multiple columns (e.g., two or more columns) at a time, which can mean selecting a corresponding codebook for data spanning multiple columns. A weight update is shown as moving from left to right. In general, the systems and techniques can organize the data from the pre-trained model into groups and blocks as shown in FIG. 6, then to take a plurality of columns in a group (or in another aspect, a plurality of groups) and perform quantization according to the algorithm and then update the weights in the current group or current plurality of columns and then update the remaining weights in the other remaining groups or columns based on the updated weights from the current group or plurality of columns. For example, the approach might include quantizing the data in group 0 and group 1, generating an error value and then updating, based on the error, the weights in groups 0 and 1 and then update the weights in group 2-group 15. The systems and techniques can quantize the data in groups 2 and 3, generating an error, and updating, based on the error, the weights in groups 2 and 2 and then update the remaining group 4-group 15.

FIG. 5B illustrates an example where one block contains several groups. In some cases, a group can include multiple blocks. Further, the systems and techniques can be based on the use of columns for vector quantization in which quantization occurs over multiple columns, then the weights of the multiple columns are updated, and then the data in remaining columns are updated to incorporate the loss value from the current quantization on the output reconstructions.

The approach can also include importing a Hessian matrix for a block, based on the block structure shown in FIG. 6. Each block can cover multiple groups as shown. Each block can have a respective inverted Hessian for use in the codebook assignment, quantization and/or other processes.

In general, quantized using vector quantization can include where a set of groups in which each group has an associated a codebook. There are a set of indices in the codebook that report, for each pair or for each d weights in the original weight matrix, which vector in the codebook is used to represent the pair or d weights. As a matter of notation, the system uses the weight index I to denote the weight index I, a shape of N_{G} where N_{G} is the number of groups times G, where G is the group size over d, where D is the vector dimension. D can be one (1) or more.

In some aspects, there are multiple indices in each group. There are a group of weights, and the system can chop them up into smaller vectors, and then each vector get assigned its own index, and then when decoding, the approach is to look at each index, and retrieve the vector that is associated with the respective index and that has d-values, and put all the d-values for all the indices in the block together, and then the system can reshape the group or block into its original form.

With the concepts of FIG. 6 in mind, steps 8-12 in the vector quantization algorithm 510 of FIG. 5B operates for each block to initialize a group index and then for each block, or for the groups in the block, to initialize or assign a codebook C_{g} 512. The term C_{g} refers to the codebook (e.g., codebooks 0-15 in FIG. 6) respectively assigned to groups 0-15 in FIG. 6. In other words, since there is a codebook per group, when the vector quantization engine 504 comes to a first column in a new group, then the codebook is initialized for that group of data in the first column. Part of the process of assigning a codebook C_{g} 512 can including a scaling operation (e.g., a scaling down operation) of the data using the value 1/S as shown in line 11. The approach enables the vector quantization engine 504 to absorb changes in the columns in the current group after quantizing the data in the previous groups.

After all the codebooks are assigned to groups and/or columns in groups, then lines 13-18 involves operations such as, on a vector quantization dimensionality d (see line 13), quantizing 514 the data W using a vector quantization approach and using the codebook C_{g} for the respective group or plurality of columns in a group. The quantizing 514 step can include reference to a metric used for centroid assignment. For example, the following equation can be used to identify a value 1 which can be a nearest centroid Cᵢ in the codebook relative to the data Wᵢ as follows:

$$l = arg {min}_{l} {( [ {C}_{i , : , l} - {W}_{: , P} ] ⊙ {S}_{: , P} )}^{T} {( {H}_{P}^{- 1} )}^{- 1} ( [ {C}_{i , : , l} - {W}_{: , P} ] ⊙ {S}_{: , P} ) \qquad ( 7 )$$

where S denotes a scaling factor, (H_{P}⁻¹)⁻¹ denotes a Hessian, and the argmin operation denotes a determination of a minimal distance between data W and a centroid C. Using equation (7), a system can determine which value (which centroid in the codebook) is closest to the W value (and that minimizes the output error) and the vector quantization algorithm 510 quantizes to that value. When performing the error evaluation in line 16, the vector quantization algorithm 510 uses the inverse Hessian [H⁻¹]_{P} which then weighs what is considered the closet centroid. The approach in line 17 can include reweighing the distance between the original vector and all the centroids which can make the vector quantization engine 504 chose a different centroid because a certain centroid minimizes essentially the output error. The approach enables the choice of a centroid to represent the original weights that minimizes the output error as opposed to the weight construction error.

Using the inverse Hessian diagonal in equation (7) can weight or determine what is considered close in terms of a distance from a vector including the original data to the nearest centroid. Use of the Hessian can cause a different centroid to be chosen which is based on how that centroid minimizes the output error. In other words, the centroid can be chosen not based on specific distance to the vector but can be chosen as a centroid that represents the initial weight while minimizing the output error.

The vector quantization engine 504 is configured to find the vector that represents the vector centroids of the set of centroids that best represents the original two values of the data. The traditional way to do the evaluation is to look at which vector is just closest to the original value. But the disclosed approach includes determining what the effect is of choosing a specific vector on the output so that the vector quantization engine 504 can reweight it with the Hessian which encapsulates information learned the data that is fed through the network. The vector quantization engine 504 can choose the vector that best reconstructs the output instead of the vector that best reconstructs the original weight tensor. Again, the selection of a centroid traditionally can be one or a set of centroids that best represents the original weights where one chooses the centroid that is closest to the original weight. However, using the Hessian can provide information regarding the effect of picking a respective centroid on the output. The vector quantization engine 504 can therefore choose the centroid (or set of centroids or vector) that best reconstructs the output, rather than the centroid or vector that best represents the original weight data.

The scaling that is described for row 11 can be used because there are multiple columns being processed simultaneously. By scaling the data, it becomes easier to identify a shared codebook for the plurality of columns. The scaling ensures that there are no outlier values which makes it more difficult to find a shared codebook across multiple columns.

Quantization parameters can be set for a smaller group of weights based on a group definition and thus the approach can provide better performance. If there is a codebook for a smaller group of weights, the use of the codebook can give better performance on processing the unquantized values. Rather than using uniform integer quantization as has been done previously, the approach can include the possibility of using non-uniform quantization across a vector quantization one-dimension d or a two-dimensional vector quantization can be used as well, meaning that a plurality of columns or dimensions can be processed simultaneously.

Line 16 of the vector quantization algorithm 510 can evaluate an error in the results of step 15 regarding quantization. The error can be used in line 17 as part of a weight update step 516 which involves updating the weights in the respective block or group. Then, the remaining weights of unquantized groups or blocks are updated in step 19 of the vector quantization algorithm 510. The vector quantization algorithm 510 is used for compression or quantizing of the data or the weights. A set or array of indices would be stored at the end of the process which would represent a compressed set of data. For each index, one could look in the codebook and then fetch a two-dimensional vector. One lookup table per group would be used, or one codebook per group.

Note that the error in line 16 of vector quantization algorithm 510 differs from the error E used in the algorithm 400 in FIG. 4. The vector quantization algorithm 510 at line 16 finds a quantization value that minimizes the output reconstruction error rather than minimizes the weight reconstruction error as in the algorithm 400. A certain quantization choice affects the output, and one can precompute the Hessian value related to a quantization of a column of the weight matrix and how the quantization effects the output.

In some aspects, the approach shown in FIG. 5B can use a Hessian matrix just for the block, so that one does not have to use the whole Hessian matrix but can just use the Hessian matrix on a block basis which is much smaller and easier to process.

After the procedure in FIG. 5B is completed, the system can perform several steps to further improve model size vs perplexity trade-offs. The system can perform codebook fine-tuning to reduce output reconstruction error. In line 15 of FIG. 5B, Q is incrementally constructed from the elements of C. Since this construction constitutes a lookup of values in C, the layerwise objective can still be minimized with respect to C. The objective can be a quadratic program that is convex, which can be represented as:

$${min}_{{C}_{0 , … , {C}_{N}}} {‖ WX - QX ‖}_{F}^{2} , \qquad ( 8 )$$

where Q(C₀, . . . , C_{N}) is a look-up operation reconstructing the quantized weights from the centroids. While this objective can be minimized in a closed form, that gradient descent is considerably faster and yields equally good solutions. The gradient of Q with respect to C can be defined simply as constructing Q only involves a look-up operation. In each GD step, the values in C are updated, and Q is reconstructed using the new values in C, keeping the assignments fixed.

In practical scenarios, codebooks can be quantized to eight bits. As a further post-processing step, the system can quantize the codebook for each group of weights to signed eight-bit integers, using symmetric min-max quantization.

Further codebook compression can be performed as well. One can achieve improved model size vs perplexity trade-offs by reducing the rank of the codebook tensor C. For single tensor, C has shape N_{G}×K×D, where N_{G} is the number of groups in the corresponding weight tensor, K is the number of centroids per codebook, and D is the VQ-dimension, ≥1. The system can first sort the second dimension of C by the first value along the third dimension and reassign the indices in I accordingly. Then, the system can perform SVD on every N_{G}×K matrix along the third dimension, leading to matrices U_{d}, Σ_{d} and V_{d}, for d=1 . . . D, of shapes N_{G}×K, K×K and K×K, respectively. The system can then fold Σ into U as U′=UΣ, and rank reduce the matrix to rank k, yielding a N_{G}×k shaped matrix U″. One can rank reduce V accordingly, yielding K×k matrix V′.

Then, the system performs gradient descent on the loss of equation (7), but with respect to the codebook tensor factors U″ and V′. In each GD step, Ĉ is created as Ĉ=U″V′^{T}, and the rest of the codebook fine-tuning procedure as described earlier is followed. Lastly, only the codebook tensor factor U″ is quantized, as V′ gives very little overhead. During inference, Ĉ is quantized per codebook after construction. In some cases, such a step can be applied to 1-D VQ only.

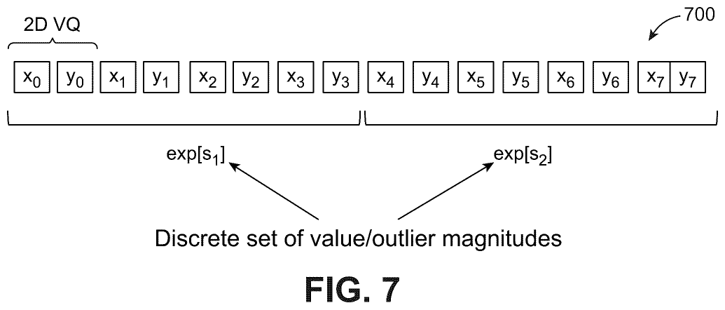

FIG. 7 illustrates data normalization for vector quantization 700. Each row in a respective group in the weight matrix can be split into scale-blocks (e.g., 8 or 16 weights). The data within the block (e.g., the blocks shown in FIG. 6) can be normalized or scaled by a scale value S. The scale value S can refer to the S value in lines 11 and 15 of the vector quantization algorithm 510. The scale can be computed as a maximal element in the block or data in a group or in a plurality of columns within a group. Using the maximal element in the scale-block can take care of outliers in the data and make the approach easier for finding a centroid from the codebook. For example, if in the scaling all the values are transitioned or scaled to values from 0 to 1, then the maximum element of data in the scale block will scale to the value of 1. In some aspects, the scale can be quantized aggressively (e.g., 4 bits or 16 values using integer quantization) to minimize the overhead in terms of storing the scale. As shown in FIG. 7, the scale can be quantized in log scale, so different scales correspond to different exponent values. Show are values s₁ and s₂ which are a discrete set of value/outlier magnitudes. In the encoding and decoding steps (e.g., steps 11 and 15) of the vector quantization algorithm 510, the data normalization shown in FIG. 7 can be used to reduce overhead. In the example, the block size can be 16 with a 4-bit scale. In such a case, normalization can be performed per group with 1024 rows. The overhead in the example can be: 4 b/16 weights+16 b/1024 rows (quantizer scale)=0.25 b+0.016 b≈0.27 b per weight, or in other words, 0.27 bits per weight of data in the pre-trained model. The vector quantization engine 504 also needs to store the quantizer scale. The 1024 rows shown above for storing the quantizer scale results in an overhead of 0.27 bits per weight. The normalization overhead is on top of the overhead of vector quantization. Thus, the data normalization or scaling as part of the encoding and decoding process helps to reduce the overhead.

In some aspects, the quantization or compression approach can involve groups and blocks as shown in FIG. 6. In another aspect, the approach could involve layers of a model such as an LLM. For example, the workflow could include loading a pre-trained model into a vector quantization engine 504 and choosing a layer. The vector quantization engine 504 could obtain some input data and sample the input data to generate activations to the layer. The vector quantization engine 504 could select a vector quantization dimensionality, a group size, a codebook bit-width and a scale groups size. These parameters can be used by the vector quantization engine 504 to generate or define a compression ratio. The vector quantization engine 504 can then quantize or compress the weights in the layer using a particular method. The weights can be updated for that layer, and then the weights for the remaining layers can be updated based on the error value. The vector quantization engine 504 can then proceed to the next uncompressed layer performing a similar process of quantization, obtaining an error, updating that layer's weights and then updating the other remaining unquantized or other uncompressed layers.

The scaling concepts disclosed herein provide a benefit of ensuring that the weights in the multiple columns are generally of a similar magnitude. If one column has weights that are much larger weights than the next column, then it can be difficult to find a shared codebook for the two columns. However, when the vector quantization engine 504 scales the columns or the groups of weights (as in line 11 of the vector quantization algorithm 510) and shapes of weights, then the scales of the weights become more similar, and it can become easier to quantize the weights using vector quantization. Line 11 includes the division by a scaling factor S and then reconstruction occurs at line 15 where, as part of the quantizing step, the weights are multiplied by S.

Normalized data on a sphere or in a circle (data normalization can enable the data to be distributed across a sphere or circle for further processing) is much easier to quantize using the codebook or centroid approach when compared to data scattered all around on a plane. Data normalization can move the data into scale books and then for each of the scale books can be the size of eight to sixteen, for example. When the data is normalized by the scale, the vector quantization engine 504 can use more elements in the scale book which allows the vector quantization engine 504 to take care of the outliners. If there is all the sudden a really large value, the then scaling would cause that value to always correspond to a value of one (in an aspect) and then based on the normalization, all the values can be quantized easily as no outlier would cause errors. After the values are scaled, there is some overhead in storing the scale itself and the scaled values. The vector quantization engine 504 can quantize the values and the lock the scale. In a decoding step, the approach can be to multiply by the scale as in line 15 of the vector quantization algorithm 510.

As noted above, systems and techniques are described herein that can perform quantization of a codebook to reduce its overhead when performing vector quantization. The vector quantization engine 504 of FIG. 5A can be the computing device that performs the codebook quantization as it relates to the vector quantization process. Individual codebooks for a different of groups described above often look similar. The similarity in codebooks implies that there are redundancies in the codebooks that can be compressed away. One approach would be to represent each codebook as a function, e.g., a low-order polynomial or low-order metalog distribution, and only transmit its parameters in low precision. However, finding the parameters means solving the least squares problem: ∥PB−C∥_{F}² for P, where P is the matrix of parameters, B is a fixed set of basis functions, and C is the codebook to be compressed. The optimal solution of finding both factors P and B to minimize the problem above is to perform a singular value decomposition (SVD) on the codebook C.

A review of multiple codebooks can reveal that they will all look very similar. There are redundancies in the codebooks that the system can compress which is why the disclosed approach can work. The system can reduce the size of the codebooks to represent each codebook as a function, which can be, for example, a low number polynomial or similar distribution. The system only needs to transmit the parameters of the polynomial in low precision. A coefficient of a third or fourth order polynomial can be used, so the system can find coefficients that fits the function very closely or exactly and quantize those coefficients and then transmit those coefficients. On device, or on a compute-core, the system can use the coefficients to reconstruct a line on a graph (such as a fairly straight line at a 45-degree angle to an x-axis) which will then reveal what the values are in the codebook at a specific point. To find the parameters means solving a least squares problem, and an appropriate way to solve a least squares problem is to use matrix decomposition or a singular value decomposition of the C matrix which has all the codebooks directly instead of going through the extra step of defining a function to represent the codebooks.

As further background on the process of quantization codebooks, consider decoding a weight tensor quantized using vector quantization as described above. An input to the vector quantization engine 504 can include a weight index tensor I of shape

$${N}_{G} \times \frac{G}{D} ,$$

where N_{G} is the number of groups the weight tensor is divided into, G is the number of weights in a group, and D is the vector quantization-dimensionality (≥1). Each index is a b-bit unsigned integer. For example, each row of C corresponds to the codebook for one group of weights. Consider a codebook tensor C of shape N_{G}×K×D, where K is the number of centroids. Generally, K=2^{b}, S_{G} is the shape of each group (rows×columns), S_{W} is the shape of the original weight tensor W (groups per column×groups per row), and N_{G} represents the groups_per_columns·groups_per_row=N_{G}. The output of the vector quantization engine 504 is a vector quantized weight W_{q}.

The procedure further includes initializing all_groups←[ ], and for each row r in I: initialize current_group←[ ]; For each index i in Iᵣ: Lookup index i in row Cᵣ, i.e. C_{r,i}; append the D values to current_group; Reshape current_group to shape S_{G}; append current_group to all_groups; and Append all groups in the shape dictated by S_{W}.

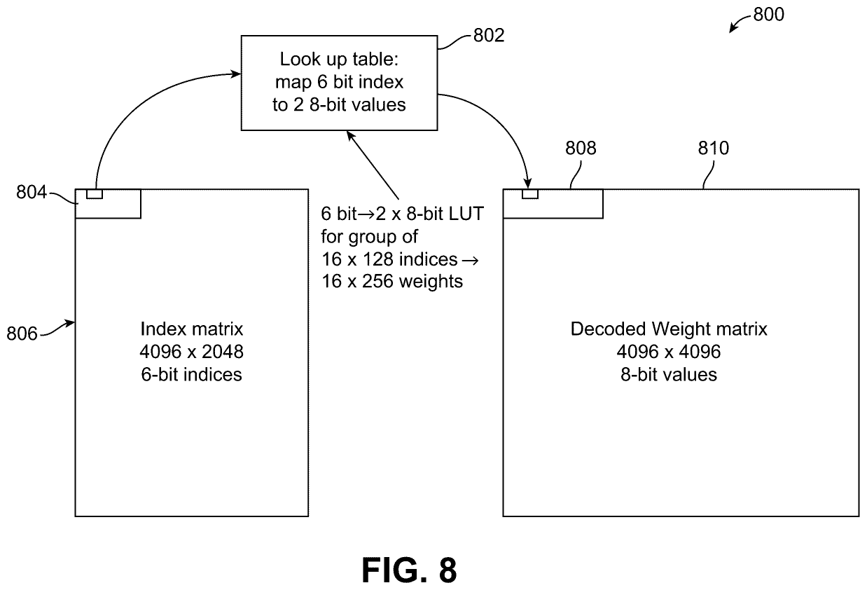

FIG. 8 illustrates the use of a look up table to transition from an index matrix to a decoded weight matrix 800, in accordance with some aspects of this disclosure. Consider a matrix 810 of 4096×4096. The approach can includes dividing the matrix into groups of 16 rows×256 columns. Each group (or index matrix 806) has an associated codebook such as a two-dimensional codebook 802 or look up table. In one example, the two-dimensional codebook 802 has indices that are 6-bit and each index maps to two 8-bit values. The two 8-bit values correspond to values in the same row and two consecutive columns 804 of the index matrix 806 and the same row and two consecutive columns 808 of the matrix 810.

In the example, the two-dimensional codebook 802 is 2×64×8 bits=1024 bits. For a group size of 8196 bits, the size of the two-dimensional codebook 802 results in an overhead of 0.125 bit per value.

For example, if the original weight tensor W is 4096 rows×4096 columns, then the corresponding index matrix 806 (which can be called index matrix I) is 4096 rows by 2048 columns. The index Iᵢⱼ expands to W_{i,2j} and W_{i,2j+1}. In this example, the resulting values for S_{G}=(16,256) and S_{W}=(256,16). The systems and techniques herein reduce the size of a vector quantization codebook with limited impact on model accuracy

The approach disclosed herein involves codebook compression for vector quantized networks. The solution yields the most gains when D is small, e.g., D=1. In some aspects, the approach can be applied layerwise, but the basic principles are not limited to a layerwise application.

For each layer, the vector quantization engine 504 can vector quantize the weights and performs the other concepts disclosed herein. The layerwise approach provides one solution and another option is to perform an end-to-end fine-tuning for the model. The disclosure generally includes a number of different contributions. In one aspect, the system assumes N_{G} times the number of groups, and in that case assumes that the matrix has all the codebooks on each row. The approach can be to factorize the matrix into a lower rank matrix that has fewer values. So, if D is greater than one, the operation of factorizing is to process each matrix along the last dimensions. If there are D times a matrix that is shaped N_{G}×K, and then the system factorizes the matrices independently to a k value (with a lower-case k indicate the lower rank that the system factorizes the matrices to).

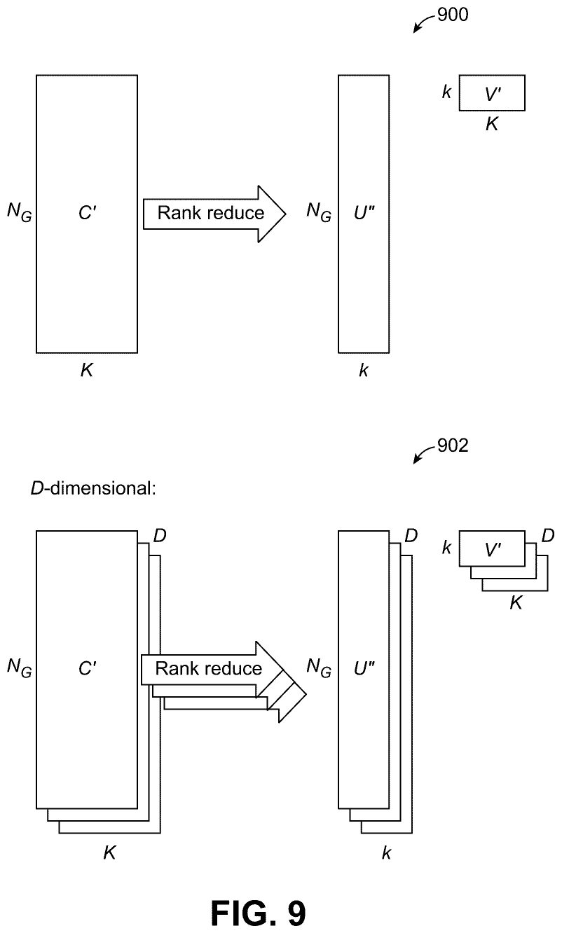

FIG. 9 illustrates the concept of rank reduction on a codebook tensor C. Rank reduction can be performed on a 1-dimensional N_{G}×K tensor of a codebook 900 which yields a tensor factor U″ of shape N_{G}×k and one tensor factor V′ of shape k×K, where k<K is the reduced rank. Rank reduction can be performed on a D-dimensional N_{G}×K×D tensor of a codebook 902, yielding D tensor factors U″ of shape N_{G}×k and D tensor factors V′ of shape k×K, where k<K is the reduced rank.

The vector quantization engine 504 can perform rank reduction on codebook tensor C of shape N_{G}×K×D as follows. The vector quantization engine 504 can sort each codebook, e.g., row in C, individually. The vector quantization engine 504 can correspondingly re-map all indices in I. If D>1, vector quantization engine 504 can sort by the first vector dimension (last dimension) index which naturally leaves the other indices unsorted. Then, the vector quantization engine 504 can follow the procedure as described below for each index along the vector dimension separately. In this case, the rank for each sub-codebook can be chosen individually.

Sorting each codebook row individually can ensure the codebooks in the first dimension all look similar, making rank reduction much more effective. The term I′ indicates an index tensor with remapped indices. The vector quantization engine 504 can perform SVD on C, yielding matrices U, Σ, V^{T}. As a result: V is shared over all codebooks for a weight tensor. In an implementation, V can be kept in memory during decoding. Performing SVD produces the three matrices U, Σ, V^{T} and then system folds the Σ matrix of singular values into U, and one can call the new matrix U′. The system can then reproduce U′ and V to the lower dimensionality.

Sorting can be performed by numerical value. If a codebook has random values (e.g., 1, −3, 4, and 8, with the value of 1 being at an index position 0, the value of −3 being at an index position 1, the value of 4 being at an index position 2, and the value of 8 being at an index position 3), the system can sort the values in the codebooks such that the index order of the values changes (e.g., to −3, 1, 4, and 8). Using the above example after the sorting is performed in a one-dimensional example, when the system encounters an index pointing at a −3 value (which was previously in index position 1, referred to as index 1), the system can ensure that the −3 value is at index 0 and that the 1 value that was previously at index 0 is now at index 1. In a multi-dimensional case, the system may use the first value in each vector and sort by the first value numerically. The system can sort by the first value and can then rearrange columns in the other dimensions to make sure that the other values match the original vector. In some aspects, the system can sort the vectors together (and in some cases can utilize the first value in the vector when sorting the vectors as noted previously). A goal of sorting can be to place the values in one dimension.

If a matrix has all the codebooks with N_{G} by K values, where N_{G} is the number of groups, and K is the number of values in each codebook, then the rank reduction converts the matrix to a matrix U″ of shape N_{G}×k and a k×K shaped matrix V′. The rank reduction can be achieved by sorting the values in each codebook in each row individually. After the parameters (e.g., weights) of layers in a machine learning model are trained, the parameters are typically in a random order. Using the above-described techniques, the parameters can be sorted, and the index matrix can be re-indexed so that the sorted values that are in the indices correspond to the now sorted values. As a result, the previous indices can be mapped to the new indices. As noted above, in multi-dimensional scenarios (D>1), where more than one value is included in each vector, the vector quantization engine 504 can sort by the values in the first dimensional V (corresponding to the highest level of the three-dimensional tensors). After storing, the system has an index tensor I′ (referred to as a modified index), instead of index tensor I. The index tensor I′ can be the same as the index tensor I, except that all the indices are re-mapped to the sorted order. Once the system has the sorted tensors, the system can perform SVD on each matrix (e.g., on one tensor in a one-dimensional scenario or on D-tensors if D is greater than one). The resulting V′ can be shared over all codebooks per weight tensors.

The vector quantization engine 504 can then fold the matrix Σ (e.g., singular values of the matrix) into U: U′←UΣ. Folding the matrix Σ (e.g., singular values) into U instead of V can make U′ less sensitive to quantization noise. The vector quantization engine 504 can rank-reduce U″ and V′ to dimensionality k<K by removing the last K−k columns of U′ and V to generate matrix U″ and V′. For instance, as shown in FIG. 9, the output of the rank reduction can be a matrix U′ that is N_{G}×K and a matrix V that is K×K. The system can then remove the last columns of the U′ matrix to generate U″ (e.g., which is N_{G}×k). The system can also remove the last rows from V to generate V′ (e.g., which is k×K).

Given layer input data X, the vector quantization engine 504 can perform stochastic gradient descent (SGD) on the tensor factors U″ and V′ to minimize layer output reconstruction error ∥WX−W_{q}X∥_{F}². The output reconstruction error relates to the difference between the quantized weights Wq and the original weights W. Better accuracy in the final quantized network can be achieved by minimizing the output of the matrix product instead of the individual matrices. To perform SGD, the vector quantization engine 504 can perform an iterative process until convergence. For example, the vector quantization engine 504 can iteratively: reconstruct codebook tensor as C′←U″V′^{T} (e.g., if D>1, the vector quantization engine 504 can reconstruct all codebooks along the vector dimension independently and concatenate the resulting codebooks together); construct a quantized weight W_{q} for I′ and C′ as described above; compute a reconstruction loss on a batch of data: [symbol] =∥WX−W_{q}X∥_{F}²; compute gradients g_{U″} and g_{V′} of [symbol] with respect to U″ and V′; and update U″ and V′ using gradients g_{U″} and g_{V′} via a gradient-based optimizer. Various gradient-based optimizers can be used, such as Adam, which is an algorithm for first-order gradient-based optimization of stochastic objective functions. The above procedure can be used to ensure outputs from layers are more faithfully restored, rather than the original codebooks.

The tensor factor U″ can then be quantized to a low bitwidth (e.g., a bitwidth less than a threshold bitwidth). In some aspects, the low bitwidth can be defined as 8-bits or lower (e.g., the threshold bitwidth is 8-bits). Any other threshold bitwidth may also apply. In some aspects, V′ is not quantized as its size (e.g., k×K) is negligible compared to U″ (N_{G}×k; N_{G}»K). In some aspects, an evaluation of the size of V′ can be performed to determine if the size meets a threshold for quantization. Standard integer quantization techniques can be used for quantizing the tensor factor U″. A result is a codebook size reduction of

$$\frac{D ( {N}_{G} \times k + k \times K )}{{N}_{G} \times K \times D} = \frac{k}{K} + \frac{k}{{N}_{G}} .$$

In some cases, symmetric sign integer quantization can be used to perform the integer quantization.

According to various aspects, the vector quantization engine 504 can perform additional optimizations. In some examples, the vector quantization engine 504 can share V over multiple weight tensors. For instance, in one-dimensional vector quantization, there are few benefits to having K>16. In some aspects, the overhead of V′ compared to U″ is negligible. In higher-dimension vector quantization, K grows exponentially to maintain performance, and the size of the groups N_{G} can grow proportionally. However, if higher dimensional vector quantization is performed, K can grow exponentially to maintain performance, a three-bit index can be present in one-dimensional vector quantization and a six-bit index can be present in two-dimensional vector quantization. As a result, the overhead changes from 8 indices to 64 indices. To make sure that overhead is still manageable, the vector quantization engine 504 can grow the block size proportionally.

For higher-dimension vector quantization, V′ can be shared over multiple weight tensors. As V′ is shared, the codebooks for multiple weight tensors can be concatenated and the techniques described above can be performed on the concatenated codebook tensor. For instance, when changing from one-dimensional vector quantization of a block size of 128 (for one-dimensional, three-bit vector quantization) to two-dimensional three-bit vector quantization, the block size can be multiplied by 8, resulting in a block size of 1,024. There are fewer codebooks per weight tensor in such a case. The system can also share the matrix V′ over fewer codebooks so the overhead of the matrix V′ becomes relatively larger. The overhead of V′ is relatively small, but can increase as the bitwidth, vector quantization dimensionality, etc. becomes larger and/or the block sizes become smaller. For higher dimensional vector quantization, the V′ tensor can be shared over multiple weight tensors. One potential procedure in such a case is to concatenate all the codebooks for multiple weight tensors.

In some aspects, as noted previously, the codebooks C⁽ⁱ⁾, C^{(j)}, C^{(k)} for layers i, j, k, with shapes N_{G}⁽ⁱ⁾, N_{G}^{(j)}, N_{G}^{(k)} respectively can be concatenated into one codebook tensor C^{(concat)} of shape (N_{G}⁽ⁱ⁾+N_{G}^{(j)}+N_{G}^{(k)})×K×D, resulting in three codebook tensors stacked on top of each other. The system can then perform rank reduction, SGD, and quantization of the tensor to the low-bit value as discussed above. The SGD fine-tuning step described above can be performed for individual layers by keeping the (shared) V′ tensors fixed. In some aspects, the system may not be able to perform SGD fine-tuning for the three layers at the same time. To address such an issue, the system can fix the values of the V′ tensor and only fine-tune the U″ tensors for each of the matrices. The system can obtain the U″ matrices by splitting the shared U matrix into the original blocks.

By perform vector quantization in one or more dimensions, the systems and techniques described herein can progressively improve quantized model accuracy. The systems and techniques can quickly quantize large deep neural networks using vector quantization (VQ). The systems and techniques achieve state of the art model size versus accuracy trade-offs on a wide range of deep neural networks (e.g., LLMs) and zero-shot tasks. The VQ techniques provide a hardware-feasible alternative to uniform quantization as a compression method, yielding increased tokens per second at the same accuracy and higher accuracy for a fixed tokens per second budget.

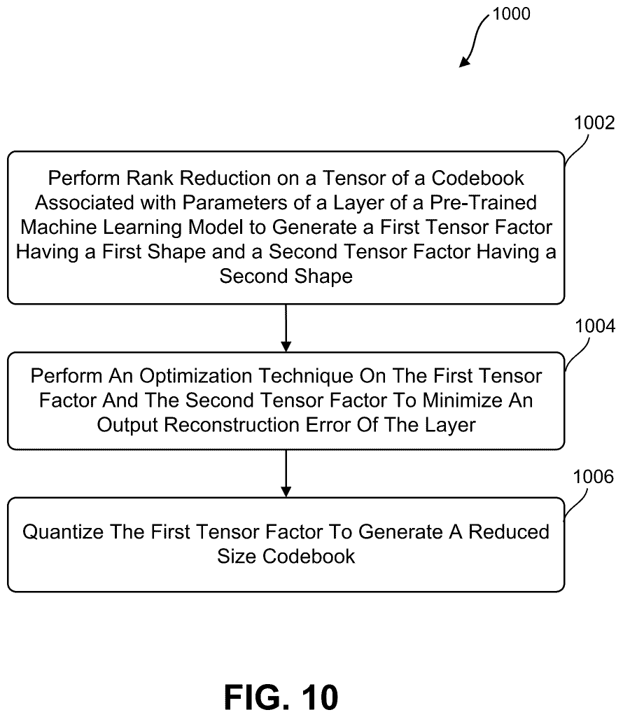

FIG. 10 is a flowchart illustrating an example process 1000 for quantizing or compressing one or more codebooks used in vector quantization of a pre-trained model using one or more of the techniques described herein. In some examples, the process 1000 can be performed by a computing device or apparatus or a component or system (e.g., one or more chipsets, one or more processors such as one or more GPUs, CPUs, DSPs, neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device or apparatus. In one example, the process 1000 can be performed by one or more of the vector quantization engine 504 of FIG. 5, the computing system 1200 of FIG. 12, or a combination thereof. For instance, a computing device with the computing device architecture of the computing system 1200 shown in FIG. 12 can implement the operations of FIG. 10 and/or the components and/or operations described herein with respect to any of FIGS. 4, 5A, 5B, 8, 9, 10 and/or 11.

At operation 1002, the computing device (or component thereof) can be configured to, and can, perform rank reduction on a tensor of a codebook associated with parameters of a layer of a pre-trained machine learning model to generate a first tensor factor having a first shape and a second tensor factor having a second shape.

In some aspects, to perform the rank reduction on the tensor of the codebook, the at least one processor can be further configured to sort each row in the codebook individually; re-map all indices in an index of the codebook to generate a modified index I′ representing an index tensor with remapped indices; perform singular value composition on the codebook to generate a first matrix, a second matrix and a third matrix; fold the second matrix into the first matrix to generate a fourth matrix; and remove a last number of columns of the fourth matrix and the second tensor factor.

In some aspects, the at least one processor can be further configured to perform rank reduction on the tensor of the codebook to generate the first tensor factor having the first shape and the second tensor factor having the second shape.

At operation 1004, the computing device (or component) can be configured to, and can, perform an optimization technique (e.g., stochastic gradient descent (SGD)) on the first tensor factor and the second tensor factor to minimize an output reconstruction error of the layer.

In some aspects, to perform the optimization technique on the first tensor factor and the second tensor factor, the at least one processor of the computing device (or component) can be further configured to: reconstruct a codebook tensor; construct quantized weights for an index and the codebook tensor; compute a reconstruction loss on a batch of data; compute a first gradient and a second gradient of the reconstruction loss with respect to the first tensor factor and the second tensor factor; and update the first tensor factor and the second tensor factor using the first gradient and the second gradient using a gradient-based optimizer.

In some aspects, operation 1004 related to performing the optimization technique on the first tensor factor and the second tensor factor can further include performing stochastic gradient descent on the first tensor factor and the second tensor factor. In some aspects, the at least one processor of the computing device (or component) can be configured to perform the optimization technique based on a given layer input data.

At operation 1006, the computing device (or component) can be configured to, and can, quantize the first tensor factor to generate a reduced size codebook.

In some aspects, the tensor includes dimensions include N_{G}×K×D, and the first shape of the first tensor factor can be N_{G}×k and the second shape of the second tensor factor can be k×K.

In some aspects, the at least one processor of the computing device (or component) can be further configured to perform the optimization technique on the first tensor factor and the second tensor factor to minimize an output reconstruction error based on a reconstruction loss.

In some aspects, the at least one processor of the computing device (or component) can be further configured to quantize the first tensor factor to generate the reduced size codebook to a bitwidth less than a threshold bitwidth. In some aspects, the threshold bitwidth can include 8 bits.

In some aspects, the at least one processor of the computing device (or component) can be further configured to quantize only the first tensor factor to generate the reduced size codebook.

In some aspects, an apparatus for quantizing one or more machine learning models can include one or more: means for performing rank reduction on a tensor of a codebook associated with parameters of a layer of a pre-trained machine learning model to generate a first tensor factor having a first shape and a second tensor factor having a second shape; means for performing an optimization technique on the first tensor factor and the second tensor factor to minimize an output reconstruction error of the layer; and means for quantizing the first tensor factor to generate a reduced size codebook.

In some aspects, a computer-readable device storing instructions is disclosed which, when executed by at least one processor, cause the at least one processor to be configured to: perform rank reduction on a tensor of a codebook associated with parameters of a layer of a pre-trained machine learning model to generate a first tensor factor having a first shape and a second tensor factor having a second shape; perform an optimization technique on the first tensor factor and the second tensor factor to minimize an output reconstruction error of the layer; and quantize the first tensor factor to generate a reduced size codebook.

In some aspects, an apparatus can compress a codebook used for quantizing a pre-trained model. The apparatus can include one or more memories configured to store the codebook and one or more processors coupled to the one or more memories and configured to: perform rank reduction on a tensor of the codebook to generate a first tensor factor having a first shape and a second tensor factor having a second shape; perform stochastic gradient descent on the first tensor factor and the second tensor factor in a manner that minimizes an output reconstruction error; and quantize only the first tensor factor to generate a reduced size codebook.

In some aspects, the computing device (or component) can be configured on an edge device of a network or on a mobile device.

In some aspects, the computing device (or component) can include an apparatus to provide approaches for compressing pre-trained models including codebooks used in pre-trained models, the apparatus can include one or more memories (e.g., memory 1215, ROM 1220, RAM 1225, cache 1212 or combination thereof) configured to store input data; and one or more processors (e.g., processor 1210) coupled to the one or more memories and configured to: perform rank reduction on a tensor of the codebook to generate a first tensor factor having a first shape and a second tensor factor having a second shape; perform stochastic gradient descent on the first tensor factor and the second tensor factor in a manner that minimizes an output reconstruction error; and quantize only the first tensor factor to generate a reduced size codebook.

In some aspects, a non-transitory computer-readable medium having stored thereon instructions which, when executed by one or more processors, cause the one or more processors to perform operations according to any of operations 1002-1006. In another example, an apparatus can include one or more means for performing operations according to any of operations 1002-1006.

In some examples, the machine learning system can be an apparatus to provide pre-trained model compression, the apparatus can include one or more: means for performing rank reduction on a tensor of the codebook to generate a first tensor factor having a first shape and a second tensor factor having a second shape; means for performing stochastic gradient descent on the first tensor factor and the second tensor factor in a manner that minimizes an output reconstruction error; and means for quantizing only the first tensor factor to generate a reduced size codebook. For instance, a computing device with the computing device architecture of the computing system 1200 shown in FIG. 12 can implement the operations of FIG. 10 and/or the components and/or operations described herein with respect to any of FIGS. 4, 5A, 5B, 8, 9, 10 and/or 11.

Results of the use of codebook quantization have been shown to be promising. For a one-dimensional vector quantization (VQ+) codebook compression process, the number of values in a codebook can be determined by the index bitwidth i: K=2ⁱ. The codebook values can be assumed to be 8-bit. For a given index bitwidth i and group size G, bits per value can be computed as

$$i + \frac{{2}^{i} \cdot 8}{G} .$$

Trade-off between bits per value for one combination of i and G, and average accuracy on a suite of LLM tasks for Llama-v2-chat can be shown. The best models have low bits per value and high accuracy. Studies show that when comparing full rank (uncompressed) codebook results with 25%, 50%, 75% and 87.5% rank reduced results, a compressed-codebook one-dimensional vector quantization at smaller group sizes can be competitive to uncompressed codebooks and sometimes outperforms uncompressed codebook.

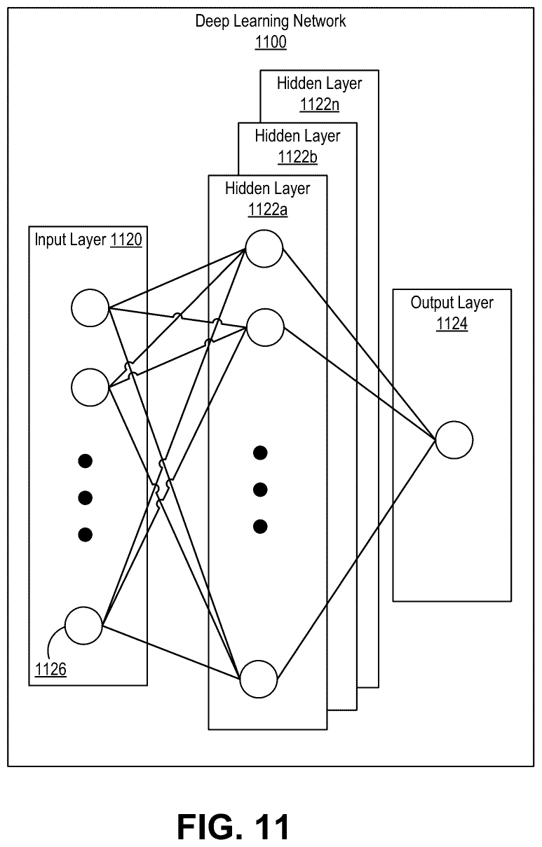

As described herein, the neural network 1100 of FIG. 11 may be implemented using a neural network or multiple neural networks. FIG. 11 is an example of a deep learning neural network 1100 that can be used by the neural network 1100 of FIG. 11. An input layer 1120 includes input data. In some examples, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1124 that provides an output resulting from the processing performed by the hidden layers 1122a, 1122b, through 1122n. In some examples, the output layer 1124 can provide a classification for an object in an input video frame. The classification can include a class identifying the type of object (e.g., a person, a dog, a cat, or other object).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layers 1122a, 1122b, through 1122n can transform the information of each input node by applying activation functions to the information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1124. In an example in which the neural network 1100 is used to identify objects in images, the neural network 1100 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 1100 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying objects in images, the forward pass can include passing a training image through the neural network 1100. The weights are initially randomized before the neural network 1100 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

In some cases, the neural network 1100 can be trained using self-supervised learning.

The neural network 1100 can include any suitable deep network. One example includes a convolutional neural network (CNN), which includes an input layer and an output layer, with multiple hidden layers between the input and out layers. An example of a CNN is described below with respect to FIG. 12. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

FIG. 12 is a diagram illustrating an example of a system for implementing certain aspects of the present disclosure. In particular, FIG. 12 illustrates an example of computing system 1200, which can be for example any computing device making up a computing system, a camera system, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some examples, computing system 1200 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 1200 includes at least one processing unit (CPU or processor) 1210 and connection 1205 that couples various system components including system memory 1215, such as read-only memory (ROM) 1220 and random-access memory (RAM) 1225 to processor 1210. Computing system 1200 can include a cache 1212 of high-speed memory connected directly with, in close proximity to, or integrated as part of processor 1210.

Processor 1210 can include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some examples, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other clement to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for quantizing one or more machine learning models, the apparatus comprising: at least one memory; and at least one processor coupled to the at least one memory and configured to: perform rank reduction on a tensor of a codebook associated with parameters of a layer of a pre-trained machine learning model to generate a first tensor factor having a first shape and a second tensor factor having a second shape; perform an optimization technique on the first tensor factor and the second tensor factor to minimize an output reconstruction error of the layer; and quantize the first tensor factor to generate a reduced size codebook.

Aspect 2. The apparatus of Aspect 1, wherein performing the optimization technique on the first tensor factor and the second tensor factor comprises performing stochastic gradient descent on the first tensor factor and the second tensor factor.

Aspect 3. The apparatus of any of Aspects 1 or 2, wherein the at least one processor is configured to perform the optimization technique based on a given layer input data.

Aspect 4. The apparatus of any of Aspects 1 to 3, wherein the tensor includes dimensions comprising NG×K×D, and wherein the first shape of the first tensor factor comprises NG×k and the second shape of the second tensor factor comprises k×K.

Aspect 5. The apparatus of any of Aspects 1 to 4, wherein the at least one processor is configured to: perform rank reduction on the tensor of the codebook to generate the first tensor factor having the first shape and the second tensor factor having the second shape.

Aspect 6. The apparatus of Aspect 5, wherein, to perform the rank reduction on the tensor of the codebook, the at least one processor is configured to: sort each row in the codebook individually; re-map all indices in an index of the codebook to generate a modified index I′ representing an index tensor with remapped indices; perform singular value composition on the codebook to generate a first matrix, a second matrix and a third matrix; fold the second matrix into the first matrix to generate a fourth matrix; and remove a last number of columns of the fourth matrix and the second tensor factor.

Aspect 7. The apparatus of any of Aspects 1 to 6, wherein the at least one processor is configured to perform the optimization technique on the first tensor factor and the second tensor factor to minimize an output reconstruction error based on a reconstruction loss.

Aspect 8. The apparatus of any of Aspects 1 to 7, wherein the at least one processor is configured to: quantize the first tensor factor to generate the reduced size codebook to a bitwidth less than a threshold bitwidth.

Aspect 9. The apparatus of Aspect 8, wherein the threshold bitwidth comprises 8 bits.

Aspect 10. The apparatus of any of Aspects 1 to 9, wherein the at least one processor is configured to: quantize only the first tensor factor to generate the reduced size codebook.

Aspect 11. The apparatus of any of Aspects 1 to 10, wherein, to perform the optimization technique on the first tensor factor and the second tensor factor, the at least one processor is configured to: reconstruct a codebook tensor; construct quantized weights for an index and the codebook tensor; compute a reconstruction loss on a batch of data; compute a first gradient and a second gradient of the reconstruction loss with respect to the first tensor factor and the second tensor factor; and update the first tensor factor and the second tensor factor using the first gradient and the second gradient using a gradient-based optimizer.

Aspect 12. A method for quantizing one or more machine learning models, the method comprising: performing rank reduction on a tensor of a codebook associated with parameters of a layer of a pre-trained machine learning model to generate a first tensor factor having a first shape and a second tensor factor having a second shape; performing an optimization technique on the first tensor factor and the second tensor factor to minimize an output reconstruction error of the layer; and quantizing the first tensor factor to generate a reduced size codebook.

Aspect 13. The method of Aspect 12, wherein performing the optimization technique on the first tensor factor and the second tensor factor comprises performing stochastic gradient descent on the first tensor factor and the second tensor factor.

Aspect 14. The method of any of Aspects 12 or 13, wherein the at least one processor is configured to perform the optimization technique based on a given layer input data.

Aspect 15. The method of any of Aspects 12 to 14, wherein the tensor includes dimensions comprising NG×K×D, and wherein the first shape of the first tensor factor comprises NG×k and the second shape of the second tensor factor comprises k×K.

Aspect 16. The method of any of Aspects 12 to 15, wherein the at least one processor is configured to: perform rank reduction on the tensor of the codebook to generate the first tensor factor having the first shape and the second tensor factor having the second shape.

Aspect 17. The method of Aspect 16, wherein, to perform the rank reduction on the tensor of the codebook, the at least one processor is configured to: sort each row in the codebook individually; re-map all indices in an index of the codebook to generate a modified index I′ representing an index tensor with remapped indices; perform singular value composition on the codebook to generate a first matrix, a second matrix and a third matrix; fold the second matrix into the first matrix to generate a fourth matrix; and remove a last number of columns of the fourth matrix and the second tensor factor.

Aspect 18. The method of any of Aspects 12 to 17, wherein the at least one processor is configured to perform the optimization technique on the first tensor factor and the second tensor factor to minimize an output reconstruction error based on a reconstruction loss.

Aspect 19. The method of any of Aspects 12 to 18, wherein the at least one processor is configured to: quantize the first tensor factor to generate the reduced size codebook to a bitwidth less than a threshold bitwidth.

Aspect 20. The method of Aspect 19, wherein the threshold bitwidth comprises 8 bits.

Aspect 21. The method of any of Aspects 12 to 20, wherein the at least one processor is configured to: quantize only the first tensor factor to generate the reduced size codebook.

Aspect 22. The method of any of Aspects 12 to 21, wherein, to perform the optimization technique on the first tensor factor and the second tensor factor, the at least one processor is configured to: reconstruct a codebook tensor; construct quantized weights for an index and the codebook tensor; compute a reconstruction loss on a batch of data; compute a first gradient and a second gradient of the reconstruction loss with respect to the first tensor factor and the second tensor factor; and update the first tensor factor and the second tensor factor using the first gradient and the second gradient using a gradient-based optimizer.

Aspect 23. An apparatus for quantizing one or more machine learning models, the apparatus comprising one or more means for performing operations according to any of Aspects 12 to 22.

Aspect 24. A non-transitory computer-readable medium is provided having stored thereon instructions that, when executed by one or more processors, cause the one or more processors to perform operations according to any of Aspects 12 to 22.

What is claimed is:

1. An apparatus for quantizing one or more machine learning models, the apparatus comprising:
at least one memory; and
at least one processor coupled to the at least one memory and configured to:
perform rank reduction on a tensor of a codebook associated with parameters of a layer of a pre-trained machine learning model to generate a first tensor factor having a first shape and a second tensor factor having a second shape;
perform an optimization technique on the first tensor factor and the second tensor factor to minimize an output reconstruction error of the layer; and
quantize the first tensor factor to generate a reduced size codebook.

2. The apparatus of claim 1, wherein, to perform the optimization technique on the first tensor factor and the second tensor factor, the at least one processor is configured to perform stochastic gradient descent on the first tensor factor and the second tensor factor.

3. The apparatus of claim 1, wherein the at least one processor is configured to perform the optimization technique based on a given layer input data.

4. The apparatus of claim 1, wherein the tensor includes dimensions comprising N_{G}×K×D, and wherein the first shape of the first tensor factor comprises N_{G}×k and the second shape of the second tensor factor comprises k×K.

5. The apparatus of claim 1, wherein the at least one processor is configured to:
perform rank reduction on the tensor of the codebook to generate the first tensor factor having the first shape and the second tensor factor having the second shape.

6. The apparatus of claim 5, wherein, to perform the rank reduction on the tensor of the codebook, the at least one processor is configured to:
sort each row in the codebook individually;
re-map all indices in an index of the codebook to generate a modified index I′ representing an index tensor with remapped indices;
perform singular value composition on the codebook to generate a first matrix, a second matrix and a third matrix;
fold the second matrix into the first matrix to generate a fourth matrix; and
remove a last number of columns of the fourth matrix and the second tensor factor.

7. The apparatus of claim 1, wherein the at least one processor is configured to perform the optimization technique on the first tensor factor and the second tensor factor to minimize an output reconstruction error based on a reconstruction loss.

8. The apparatus of claim 1, wherein the at least one processor is configured to:
quantize the first tensor factor to generate the reduced size codebook to a bitwidth less than a threshold bitwidth.

9. The apparatus of claim 8, wherein the threshold bitwidth comprises 8 bits.

10. The apparatus of claim 1, wherein the at least one processor is configured to:
quantize only the first tensor factor to generate the reduced size codebook.

11. The apparatus of claim 1, wherein, to perform the optimization technique on the first tensor factor and the second tensor factor, the at least one processor is configured to:
reconstruct a codebook tensor;
construct quantized weights for an index and the codebook tensor;
compute a reconstruction loss on a batch of data;
compute a first gradient and a second gradient of the reconstruction loss with respect to the first tensor factor and the second tensor factor; and
update the first tensor factor and the second tensor factor using the first gradient and the second gradient using a gradient-based optimizer.

12. A method for quantizing one or more machine learning models, the method comprising:
performing rank reduction on a tensor of a codebook associated with parameters of a layer of a pre-trained machine learning model to generate a first tensor factor having a first shape and a second tensor factor having a second shape;
performing an optimization technique on the first tensor factor and the second tensor factor to minimize an output reconstruction error of the layer; and
quantizing the first tensor factor to generate a reduced size codebook.

13. The method of claim 12, wherein performing the optimization technique on the first tensor factor and the second tensor factor comprises performing stochastic gradient descent on the first tensor factor and the second tensor factor.

14. The method of claim 12, further comprising performing the optimization technique based on a given layer input data.

15. The method of claim 12, wherein the tensor includes dimensions comprising N_{G}×K×D, and wherein the first shape of the first tensor factor comprises N_{G}×k and the second shape of the second tensor factor comprises k×K.

16. The method of claim 12, further comprising:
performing rank reduction on the tensor of the codebook to generate the first tensor factor having the first shape and the second tensor factor having the second shape.

17. The method of claim 16, wherein performing the rank reduction on the tensor of the codebook comprises:
sorting each row in the codebook individually;
re-mapping all indices in an index of the codebook to generate a modified index I′ representing an index tensor with remapped indices;
performing singular value composition on the codebook to generate a first matrix, a second matrix and a third matrix;
folding the second matrix into the first matrix to generate a fourth matrix; and
removing a last number of columns of the fourth matrix and the second tensor factor.

18. The method of claim 12, further comprising performing the optimization technique on the first tensor factor and the second tensor factor to minimize an output reconstruction error based on a reconstruction loss.

19. The method of claim 12, further comprising:
quantizing the first tensor factor to generate the reduced size codebook to a bitwidth less than a threshold bitwidth.

20. A non-transitory computer-readable medium is provided having stored thereon instructions that, when executed by one or more processors, cause the one or more processors to:
perform rank reduction on a tensor of a codebook associated with parameters of a layer of a pre-trained machine learning model to generate a first tensor factor having a first shape and a second tensor factor having a second shape;
perform an optimization technique on the first tensor factor and the second tensor factor to minimize an output reconstruction error of the layer; and
quantize the first tensor factor to generate a reduced size codebook.
